(19) United States
(12) Patent Application Publication
(10) Pub. No.: US 2014/0158574 A1
(43) Pub. Date: Jun. 12, 2014

(54) SECURITY PACKAGING

(71) Applicant: MeadWestvaco Corporation, Richmond, VA (US)

(72) Inventor: Joel E. FORBES, Richmond, VA (US)

(73) Assignee: MeadWestvaco Corporation, Richmond, VA (US)

(21) Appl. No.: 14/095,681

(22) Filed: Dec. 3, 2013

Related U.S. Application Data
(63) Continuation-in-part of application No. PCT/US12/56238, filed on Sep. 20, 2012.
(60) Provisional application No. 61/693,435, filed on Aug. 27, 2012.
(60) Provisional application No. 61/537,352, filed on Sep. 21, 2011.

(51) Int. Cl. G08B 13/24; B65D 55/02; B65D 5/50

(52) U.S. Cl. CPC G08B 13/2428; B65D 5/50; B65D 55/02
USPC 206/459.1; 220/729; 220/62

(57) ABSTRACT

A tether or insert carries a conductive trace. The tether, or insert is positioned inside a package and a security module attached to a portion of the tether or insert exposed to the outside of the package. Product conducts are attached to the tether or insert within the package. Removal of the product breaks the conductive trace and causes the security module to generate an alarm.

### REFERENCE TO RELATED APPLICATIONS

This application is a continuation in part of International Application PCT/US12/56238 filed on Sep. 20, 2012, which claims the benefit of priority under 35 U.S.C. §119(e) of U.S. provisional applications Ser. No. 61/537,352 filed on Sep. 21, 2011 and 61/693,435 filed on Aug. 27, 2012, all of the above being hereby incorporated by reference in their respective entireties.

### FIELD OF THE INVENTION

The invention relates to a security mechanism for a package, a package including such a security mechanism and/or a component of such a security mechanism and a method of making the package and the security mechanism. More specifically, but not exclusively, the invention relates to a security device where at least one security loop is formed as a label to be applied to the package structure and to the package contents, for detecting a removal of the contents from the package, or, a breach of the package.

### BACKGROUND OF THE INVENTION

In the field of packaging it is often required to maximise the display of premium (high-cost) articles for marketing and advertising purposes in retail outlets, yet at the same time it is necessary to secure those premium articles against theft or damage. Electronic article surveillance (EAS) is one known method for preventing shoplifting from retail stores. Special tags are fixed to merchandise and these tags are usually removed or deactivated at a pay counter once the article has been purchased. At the exits of the store, a detection system sounds an alarm if the security device has not been removed or deactivated and an attempt is made to remove the article from the retail outlet without paying.

In another method of theft prevention, wired alarm clips may also be used. These wired clips are wound around the exterior of an article or package. However, these known methods of securing against theft can be bulky and can obscure the product from display and/or may be vulnerable if the security tag or wired alarm is only affixed to the packaging containing the article and not the article itself. In such arrangements, by removing the article from the packaging and hence security tag, it may be possible to then take the article from the store without detection. Additionally, since it is not always possible to affix a security device directly to an article, for example, in the case of delicate or fragile articles, an alternative solution is required.

One such solution is offered by the NATRALOCK® packaging, a product made by the present applicant, which utilises a tear-resistant polymer laminated recyclable paperboard combined with an APET or RPET thermoform to create a visible package nearly impossible to tear apart by hand which deters theft in stores. Whilst, the package can be opened easily and safely with household scissors, the requirement for use of scissors introduces a difficulty to the consumer. Furthermore, this package still requires an external security module to secure against theft of the entire package.

The present invention seeks to mitigate or overcome these and other problems associated with known security devices and/or provide an improvement over known security devices.

### SUMMARY OF INVENTION

A package is provided which contains a primary article and includes a security feature having first and second parts which together are capable of detecting when the package is opened and in response to that detected opening issues an electrical signal, which electrical signal causes an alert to be issued. Preferably, the alert is an audible alarm emitted directly by the security feature. The security feature may be incorporated into a label, tether, or insert to be applied to or inside the package.

The package may have a first part of a security feature incorporated therein, the first part of the security feature being connectable to a second part of a security feature such that together, the first and second parts of the security feature are capable of detecting when the package is opened and capable of issuing an electrical signal in response to that detected opening which electrical signal is operable to cause an alert to be issued. The security feature may be incorporated into a label, tether, or insert to be applied to or inside the package.

In one embodiment, an insert is provided for inserting into or onto a carton and connecting to a security device, the insert including a substrate sheet, a conductive trace on the substrate sheet, an adhesive on at least a portion of the substrate sheet; and a release liner on at least a portion of the adhesive. The insert may be a label.

In another embodiment, a tether is provided for inserting into or onto a carton and connecting to a security device, the tether including a substrate sheet, a conductive trace on the substrate sheet, the conductive trace having a first end and a second end, the first and second end being positioned and sized to be connected to the security device.

In another embodiment, an insert is provided for placing into or onto a package and connecting to a security device, the insert including a support sheet, a tongue cut into the support sheet, the tongue having a proximal end remaining attached to the support sheet and a distal end opposite from the proximal end, an opening in the support sheet adjacent the tongue distal end, a conductive trace on the support sheet and extending across the proximal end of the tongue, the conductive trace including a pair of contacts at a first end of the conductive trace, and a free portion at a second end of the conductive trace, the free portion extending past the tongue distal end and positioned over the opening in the support sheet.

In additional aspects, a package is provided which contains the insert, tether, or label.

In other aspects, a kit of parts is provided for forming a package, including the insert, label, or tether and one or more paperboard cards or panels sized to receive the insert, tether, or label loosely or in facing contact.

According to certain aspects, the security loop is formed as part of an insert, label or tether to be applied to or in the package and includes two terminals, each connectable to the second part of the security feature and said second part of the security feature is operable to issue an alert by sounding an alarm and/or by illuminating a light and/or by transmitting an electromagnetic signal. The portion of the security loop formed on the label may be electrically conductive and may be formed from conductive printed ink, conductive ribbon, conductive foil and/or conductive wire.

The second part of the security feature may be formed as a separate module that is connectable to and removable from the package.

Optionally, the second part is formed as a separate module that is removable from the package and the package further includes an integral retaining means for retaining and releasing the module.

Optionally, in any of the aspects, the security loop may be formed with a portion associated with the contents of the package, such that removing the contents from the package, or detaching the contents from the package, breaks the security loop.

Optionally, the security module may provide a hang hole, or be associated with an existing hang hole on the package.

Optionally, in certain of the aspects, the security module may cover or obscure an easy-open feature such as a nick or tear in the package, by which the package can be opened after removal of the security module.

A further aspect of the invention provides a kit of parts for forming a package having an integral security feature, the kit of parts comprising one or more blanks for forming the package, an insert, tether, or label having a first part of a security feature incorporated therein, the label sized to be received into or onto the package; one or more articles to be contained in the package; and a second part of the security feature comprising an electronic circuit capable of connecting to the first part of the security feature and capable of detecting a breach of the package integrity and in response to that detected breach issues an electrical signal, which electrical signal causes an alert to be issued.

### BRIEF DESCRIPTION OF THE DRAWINGS

Exemplary embodiments of the invention will now be described with reference to the accompanying drawings, in which perspective views are shown of the following:

FIG. 1 shows a perspective view of a package with a security loop for monitoring the presence of a product within the package;

FIG. 2 shows a view of a package before adding a security loop;

FIGS. 3A and 3B show front and back views of a label including a security loop;

FIGS. 4A and 4B show steps in preparing the label of FIGS. 3A and 3B for placement into a package;

FIG. 5 shows the label of FIG. 4B being placed into a package of FIG. 2;

FIG. 6 shows a cutaway view of the package of FIG. 5, after the label is placed into the package;

FIG. 7 shows a cutaway view of a step in preparing the label for receiving a product item into the package;

FIG. 8 shows a cutaway view of the product item received into the package and attached to the label;

FIG. 9 shows a view of the package of FIG. 8 containing the product item;

FIG. 10 shows a step in closing the package of FIG. 9;

FIG. 11 shows the closed package of FIG. 10, with a security module being attached;

FIG. 12 shows a cutaway view of the label being disrupted when the product has been removed from the label;

FIGS. 13A and 13B show alternative package and label designs;

FIGS. 14A, 14B, 15A and 15B show an alternative structure to the label of FIG. 3;

FIG. 16A shows a plan view of another security loop, and FIG. 16B shows the security loop on a backing sheet;

FIG. 17A shows a plan view of an insert card for holding the security loop of FIGS. 16A and 16B, and FIG. 17B shows the security loop attached to the insert card;

FIGS. 18A and 18B show perspective views of the insert card from the front and back;

FIG. 19 shows a perspective view of a package using the insert card, and containing an item;

FIG. 20 shows a cross section view of the package of FIG. 19;

FIGS. 21A-21J show cross section views of variations on the structure of FIG. 20;

FIGS. 22A-22D show steps in assembling a package;

FIG. 23A shows a plan view of a blank for making a carton with a security loop;

FIG. 23B shows the carton made from the blank;

FIG. 24 shows a plan view of another blank for making a carton with a security loop;

FIG. 25 shows a plan view of the blank of FIG. 24, with the panel carrying the security loop folded over;

FIG. 26 shows a plan view of another blank for making a carton with a security loop;

FIG. 27 shows a plan view of the blank of FIG. 26, with the panel carrying the security loop folded over;

FIG. 28A shows a perspective view of blanks for making a blister card with a security loop carried on a foldover card;

FIG. 28B shows the blanks of FIG. 28A, with the foldover card folded from the side;

FIG. 28C shows a blister being placed between the cards of FIG. 28B;

FIG. 28D shows a finished blister package made from the blanks of FIG. 14A;

FIG. 29A shows a perspective view of other blanks for making a blister card with a security loop carried on a foldover card;

FIG. 29B shows the blanks of FIG. 29A, with the foldover card folded from the top;

FIG. 29C shows a blister being placed between the cards of FIG. 29B;

FIG. 29D shows a finished blister package made from the blanks of FIG. 15A;

FIG. 30A shows a plan view of a security loop supported on a substrate; and

FIGS. 30B-30D show detail views of possible features of the substrate shown in FIG. 16A.

FIGS. 31A-31D show detail views of other cut arrangements in the security loop;

FIG. 32 shows a tether with a tear-initiation feature; and

FIGS. 33A-33C show additional tethers of varying designs.

### DETAILED DESCRIPTION OF PREFERRED EMBODIMENT

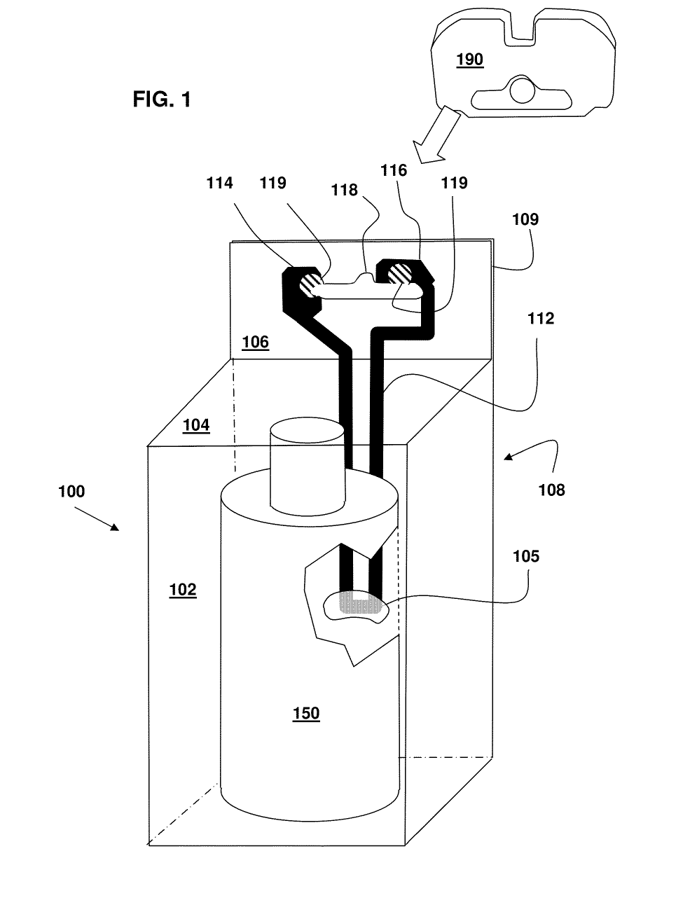

FIG. 1 shows a package 100 with security feature as described in U.S. patent application Ser. No. 12/975,635, filed Dec. 22, 2010, which is incorporated herein by reference in its entirety. Folding carton 100 is shown in FIG. 1 with some of its panels transparent so that the interior of the package is visible. A conductive pathway or conductive trace 112 is provided on a back panel 108 which has a hang hole 118. The hang hole provides a location to expose the ends of conductive trace 112 and a place to attach an electronic surveillance module 190. The conductive trace could be a label with conductive ink printed on it or a laminated aluminum foil/paper substrate with the trace die-cut in a specific pattern. The trace could be provided directly on the package. The traces run from the module 190 to the vicinity of a product item 150.

Package 100 may be a container such as a paperboard carton holding a product item 150 such as a bottle. The product 150 may be attached to a portion of conductive pathway 112 by a securing means 105. Securing means 105 may be a securing material, such as a glue dot or blob. A fugitive glue may be used. The product 150 may advantageously be positioned closely to the package wall that supports the conductive pathway 112, making securing material 105 relatively inaccessible to a thief so that it is difficult or impossible to cut through the securing material 105.

Package 100 may include a back panel 108 supporting conductive pathway 112. The package may include other panels, for example front panel 102 and top panel 104. The conductive pathway may extend upward from back panel 108 onto back panel extension 109 on which the conductive pathway may terminate in a pair of contacts 114, 116. These contacts may be located adjacent or partly contiguous with hang hole 118. The package shown in FIG. 1 advantageously may remove the need for conductive pathway 112 to cross any fold lines. If the back panel extension 109 is covered in front by top panel extension 106 (or another panel), one or more contact access holes 119 may be provided in top panel extension 106 (or the other panel or panels) to provide contact access for security module 190.

The package may have one or more transparent or open windows to allow the customer to view or touch the product 150. Since the securing means 105 will break the conductive pathway 112 if the product is removed, the package 100 may be relatively open and may have fewer panels than shown in FIG. 1.

The security module may be disarmed by a tool or other mechanism. Once disarmed, the security module 190 can be removed from the package and the module 190 can then be reused. An attempt to disconnect the security module 190 from the package before the security module 190 is switched off will cause the alert to be issued.

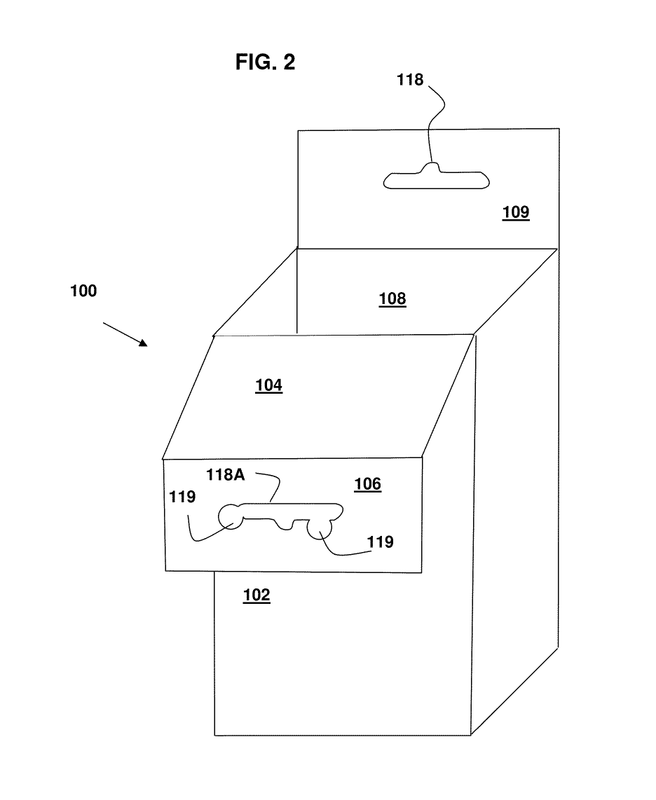

Embodiments of the invention are depicted in FIGS. 2 to 14. It will be understood that the foregoing description and accompanying drawings are representative of non-limiting examples of how the present invention can be implemented.

The packages of FIGS. 1-14 may be made from one or more blanks (not shown). The blank or blanks may be formed of paperboard, or other suitable sheet material in alternative embodiments, for example: paper, cardboard, plastics material, coated paperboard and polymer laminated paperboard (such as NATRALOCK®).

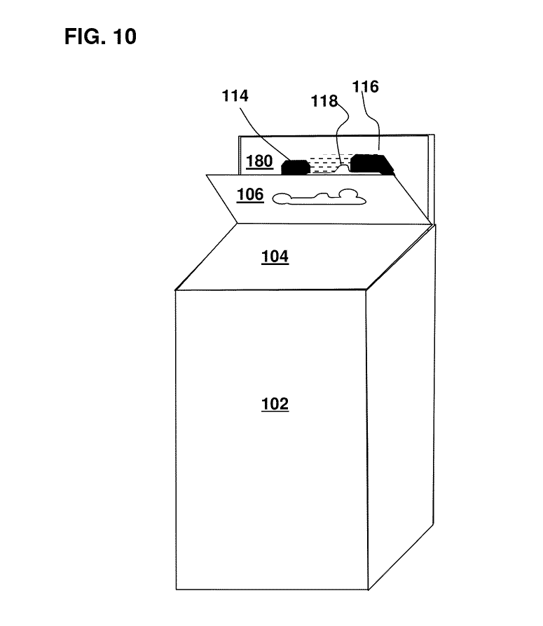

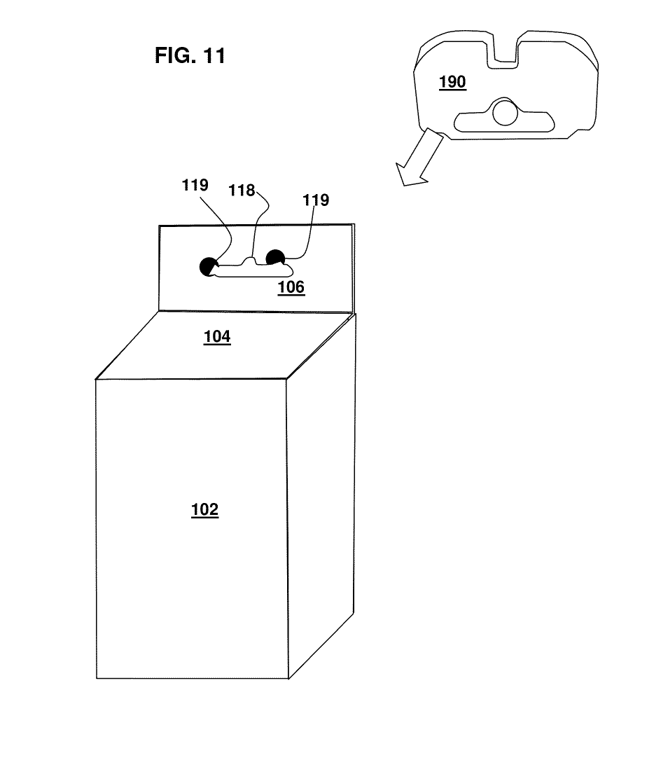

FIG. 2 shows an empty package or carton 100, including several panels including for example front panel 102, top panel 104, top panel extension 106, back panel 108, and back panel extension 109. The back panel extension 109 may have a hang hole 118 and the top panel extension 106 may have a corresponding hang hole 118A that may include one or more contact access holes 119. In the finished package as shown in FIGS. 10 and 11, the contact access holes may coincide with contacts 114, 116.

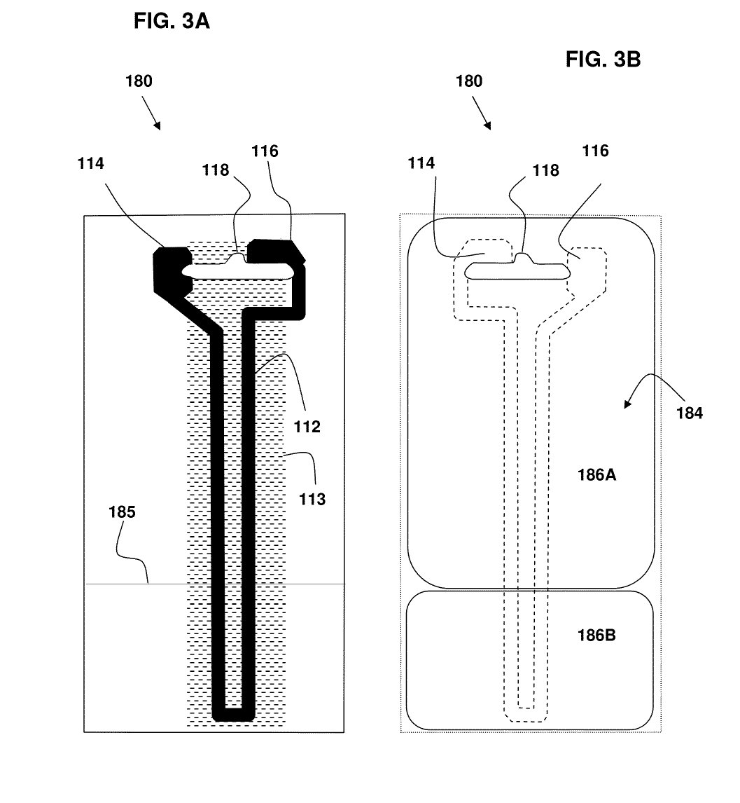

FIG. 3A shows a first side of a label 180 which supports a conductive loop or trace 112 that may be formed of conductive ink. The label may be formed from a substrate sheet material such as paper, plastic, or the like. Using conductive ink is beneficial because it can be easily printed onto the label 180. This ink may be printed onto the label using regular printing press methods. The ink should be allowed to dry. It may take up to five minutes or up to ten minutes or longer depending upon conditions for the conductive ink to fully set. After the conductive ink is printed and set then the label 180 is further processed for example by application of adhesive 188 and a release liner 184. The label may be selectively weakened by perforations, slits, holes, or other weakening features 113 that may make the label susceptible to tearing under certain circumstances. Such tearing may preferably break the trace 112 and therefore the weakening features 113 may be located proximate to trace 112. The label 180 may have one or more label fold lines 185 formed therein.

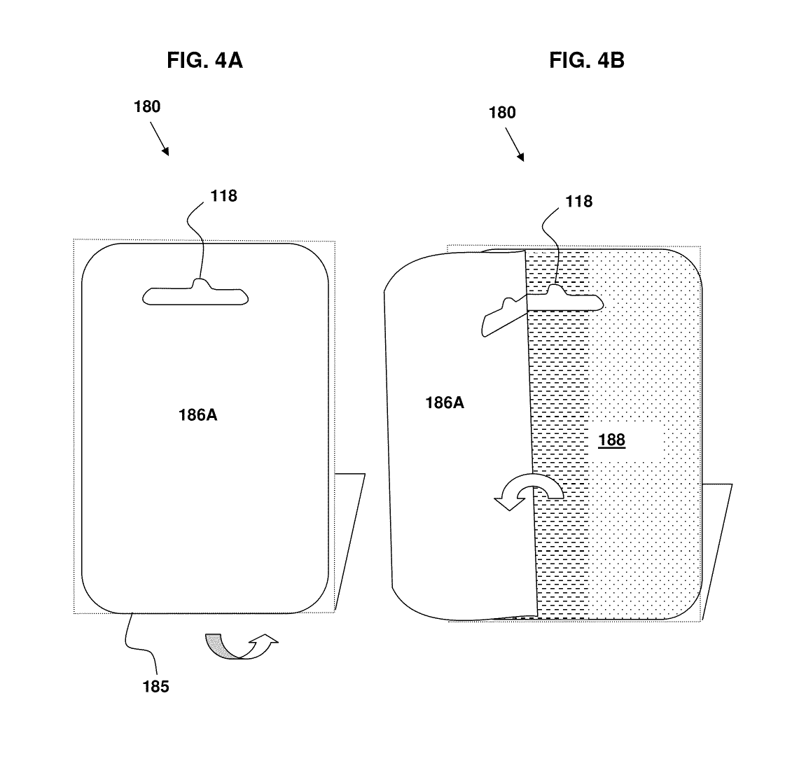

FIG. 3B shows the second side of the label, which may be coated by an adhesive 188 (see FIG. 4B) that may be covered by a release liner 184. The release liner 184 may have one or more separable portions including primary portion 186A and secondary portion 186B, etc. that may be selectively removed from the label. More than two separable portions may be provided. The juncture between any two portions may coincide with a label fold 185.

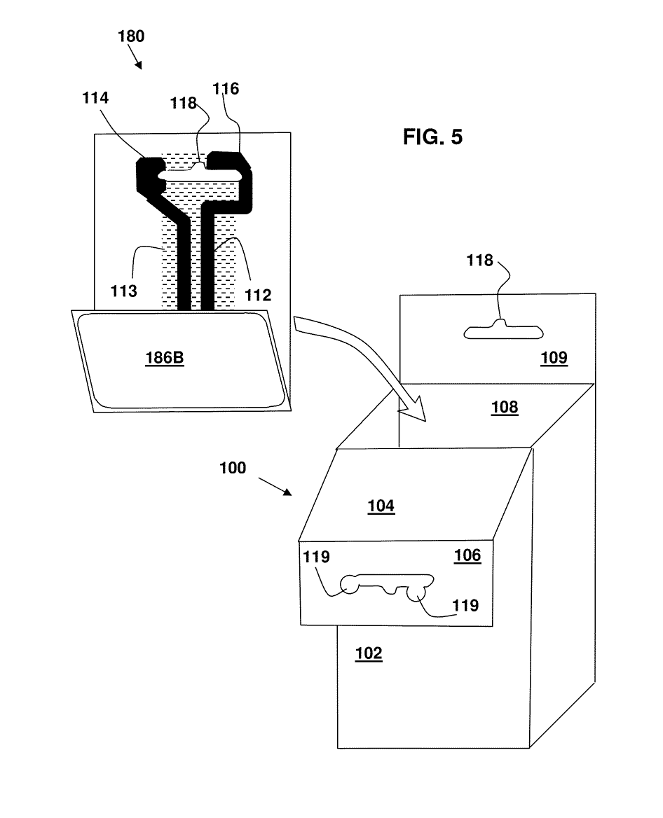

The size and shape of the separable portions of the release liner may be chosen according to manufacturing preference. For example primary portion 186A may occupy much of the upper part of label 180, as shown, to provide a strong attachment to the inside of the package when it is applied as described in later in relation to FIG. 5. Also for example, primary portion 186A might be located away from the side edges of label 180, or away from fold line 185, so as to more readily allow the label to be placed into the package (for example by a sliding motion where one or more edges are slid along an inside corner of the package). Keeping the primary portion 186A away from the immediate side edges of the label, or the fold line, might allow a more easy placement into the package, and once the label is properly located in the package, it could then be firmly adhered to the inside of the package. As another example, secondary portion 186B might be limited to an area in the vicinity of conductive trace 112, provided that the product item would be sized and shaped to contact the adhesive exposed by removal of the secondary portion. The other parts of the lower end of the label 180 might be left without adhesive exposed, for example to prevent sticking the label to brochures or other contents besides the product item.

Although the adhesive 188 and release liner 184 are shown on a second side of the label 180, opposite from the first side, it is also possible that the adhesive and release liner might be provided on the same side as the conductive trace 112. Alternately, the adhesive and release liner may be provided on both sides.

With regard to the presence of conductive trace 112 on the label (and later within the package) It is to be understood that a variety of tools may be used to apply the graphics to the package and/or seal the package, and that each set of tools may affect the appropriate pressure and temperature ranges that may be applied without disrupting the functionality of the conductive ink. A broad range of temperatures and pressures may be used to seal the package, for example, but not limited to, a pressure of 20 to 80 psi and a temperature of 300-400° F. In one example, the package may be sealed using a pressure of about 50 psi and a temperature of about 350° F. Other ranges for pressure and temperatures may also work to seal and print the graphics without damaging the ink's conductive properties depending upon the conditions, equipment and materials used. Damage or change in the conductive properties of the conductive ink material could cause the security feature to fail. The pressure and temperature limits may vary based on the materials used. Development of conductive inks may alter these temperature and pressure considerations. It is to also be understood that the exact order of these sequences may be adjusted depending upon manufacturing preferences.

The conductive ink used for printing the security loop may be replaced with other suitable means for allowing an interruption of that loop to be conveyed to an alert means. Other electrically conductive materials readily could be used in replacement of or in combination with the conductive ink, for example: foil ribbon, wire and conductive plastics or polymer material. In the present example, a conductive material is used so that a break or interruption in the security loop 112 causes an increased resistance within an electronic circuit to which the security loop 112 is coupled which results in an alarm sounding. The security loop 112 or label 180 may be formed from material that can readily be torn through so that the presence of a security loop incorporated within the package does not hinder a consumer gaining access to their article once the product has been purchased. It is to be understood that the module connected to the security loop may also be designed to interact with other anti-theft devices in a store. For example it could also be designed to sound if the entire package is removed from the building (e.g. when the package crosses security detection devices placed at the doors).

Depending on the position of the conductive trace 112, contact holes 119 may be provided in the top panel extension 106 or the back panel extension 109, or both, or on some other panel. The contact holes 119 superimposed upon contacts 114, 116 provides a good electrical contact area for the security module 190, including optionally allowing for a clamping force or a conductive adhesive to help maintain good electrical contact.

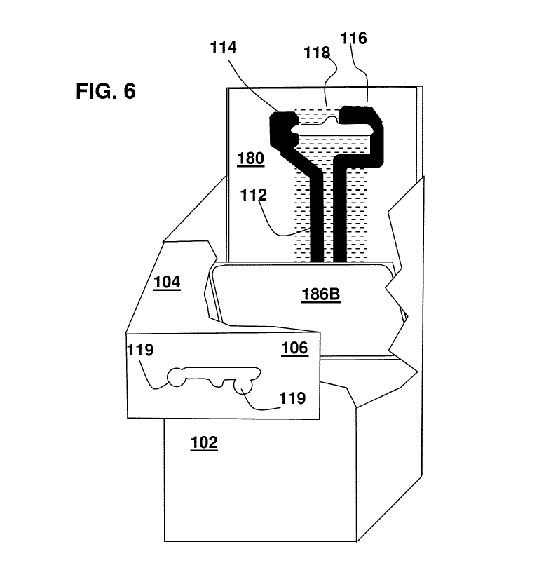

FIG. 4A shows a step in preparing label 180 for inserting into package 100. The lower part of the label (as represented by secondary portion 186B in FIG. 3B, may be folded backward about label fold line 185. Then, as shown in FIG. 4B, the release liner may be removed from primary portion 186A, exposing adhesive 188. Continuing with FIG. 5, the label is then turned around so the exposed adhesive 188 faces to the back, and the label is inserted into package 100 so that the adhesive may adhere to the inside of back panel 108. As the label 180 is inserted into the package, care is taken so that the hang hole 118 provided on the label lines up with the hang hole 118 provided in the back panel extension 109. The package and label now appear as shown in cutaway view in FIG. 6.

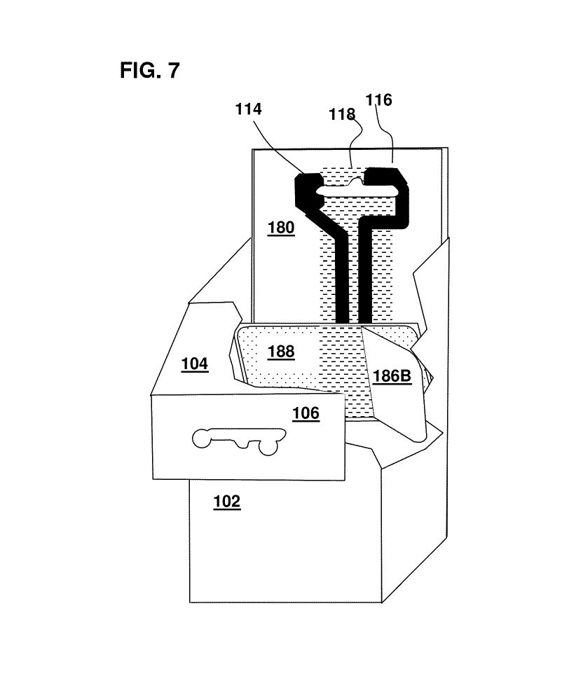

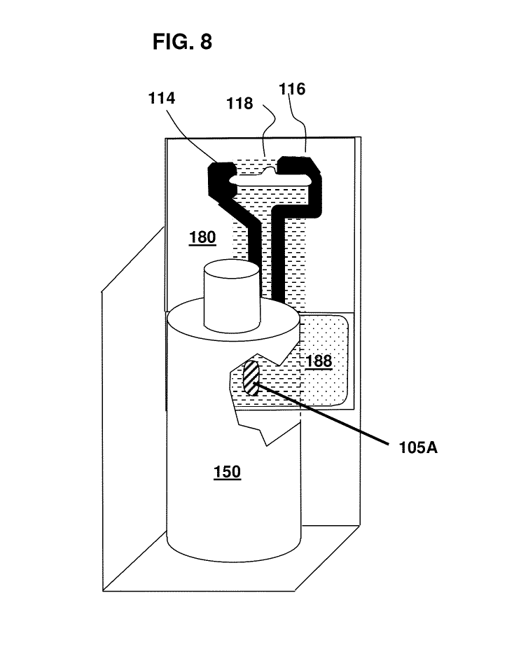

Next, as shown in cutaway in FIG. 7, the release liner may be removed from secondary portion 186B exposing adhesive 188. As further shown in cutaway view in FIG. 8, a product item 150 may then be placed into the package and adhered to adhesive 188. An adhered region or product contact area 105A will be formed, which preferably (by design of the package 100, label 180, and product 150) will be in the vicinity of a portion of conductive trace 112.

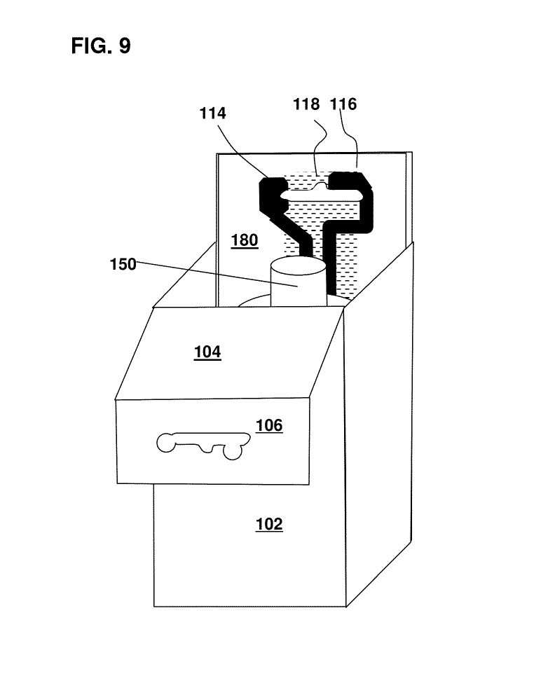

FIG. 9 shows the still-open package containing the label 180 and product 150. Next, as shown in FIG. 10, the package top 104 may be closed over the opening, bringing top panel extension 106 into proximity with the top of label 180. Finally as shown in FIG. 11, the top panel extension 106, top of label, and back panel extension 109 (not shown) may be joined together, securely closing the package. The joining together may be done by various means including but not limited to heat sealing or adhesive. A security module 190 may then be attached to the package, with its contacts making electrical contact with the terminals 114, 116 of conductive loop 112. The contact may be made through cutout areas 119 in the top panel extension 106 or back panel extension 109 or both.

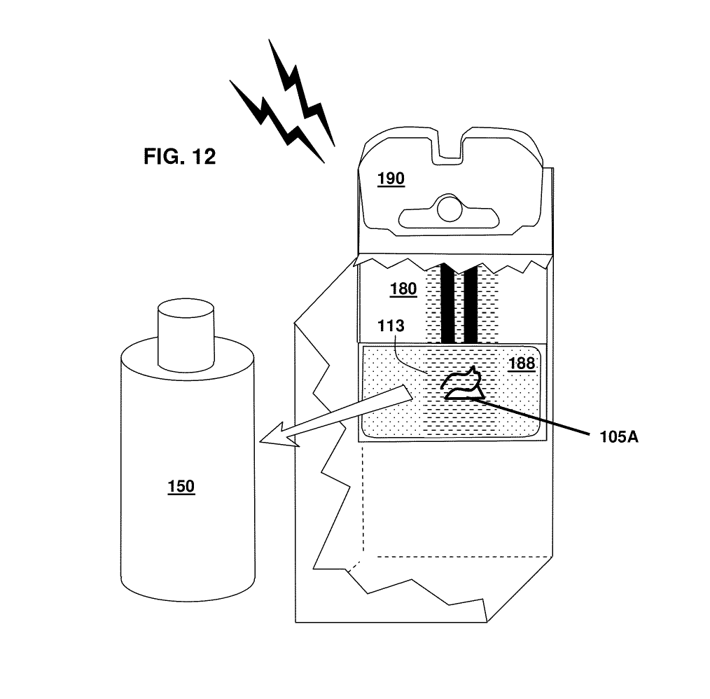

As shown in FIG. 12, it is very difficult to separate the product item 150 from the security module 190. Removing the security module from the package (unless it is deactivated) will set off the alarm. Cutting through the conductive trace 112 will set off the alarm. Attempting to detach the product 150 from the adhesive 188 will disrupt the label at product contact point 105A and break the conductive trace, and set off the alarm. (For ease in viewing FIGS. 11-13, the adhesive area 188 is not shaded in these figures.)

Ideally any adhesive 188 will be attached to or adhere strongly to the product 150, yet be capable of being removed from the product without excessive effort after purchase, either by peeling, scraping, dissolving, or otherwise removing adhesive 188 from product 150. The product may advantageously be close to the label 180, for example in close facing contact, so that a knife cannot be inserted between the product and the package to cut through the adhesive 188 without breaking the conductive pathway 112.

It will be recognized that various features of different embodiments as described herein may be utilized in combination with each other.

Although the examples shown in the Figures incorporate a single security loop, it should be understood that more than one security loop may be used. For example, the single security loop shown in FIG. 8 may be replaced by a first security loop around the perimeter of a blister, and a second security loop underlying the blister area and optionally containing a gap to be broken if the contents are removed. The first and second security loops may each have their own contacts to connect to an external security module. The security module in turn may have one pair of contacts for the first security loop and another pair of contacts for the second security loop. Portions of the circuitry within the security module, such as the resistance-measuring circuitry, may be duplicated to serve the second security loop. Some portions of the circuitry within the security module may be shared between both loops, for example the battery, switch, and audible alarm.

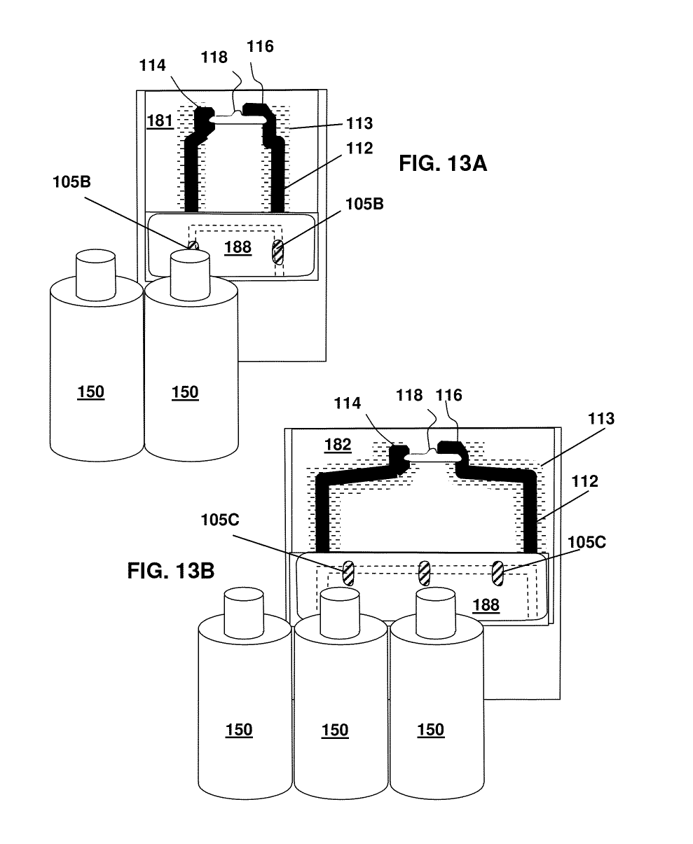

The security loop may have a different shape from that shown in FIGS. 2-12. FIG. 13A shows a package with a label 181 for securely monitoring two product items 150. For example, the lines of the conductive trace 112 that run up and down may be separated apart as shown to correspond with the lateral spacing of the two product items, so that two product contact areas 105B may be formed on the vertical lines to contact the two product items. FIG. 13B shows a package with a label 182 for securely monitoring one or more product items 150. For example, the lines of the conductive trace 112 that run up and down may be separated relatively far apart and joined together by a cross-ways line as shown so that three product contact areas 105C may be formed on the cross-ways trace to contact the three product items. Other designs may be formed according to manufacturing preference to securely monitor other numbers of products in columns, rows, arrays, etc.

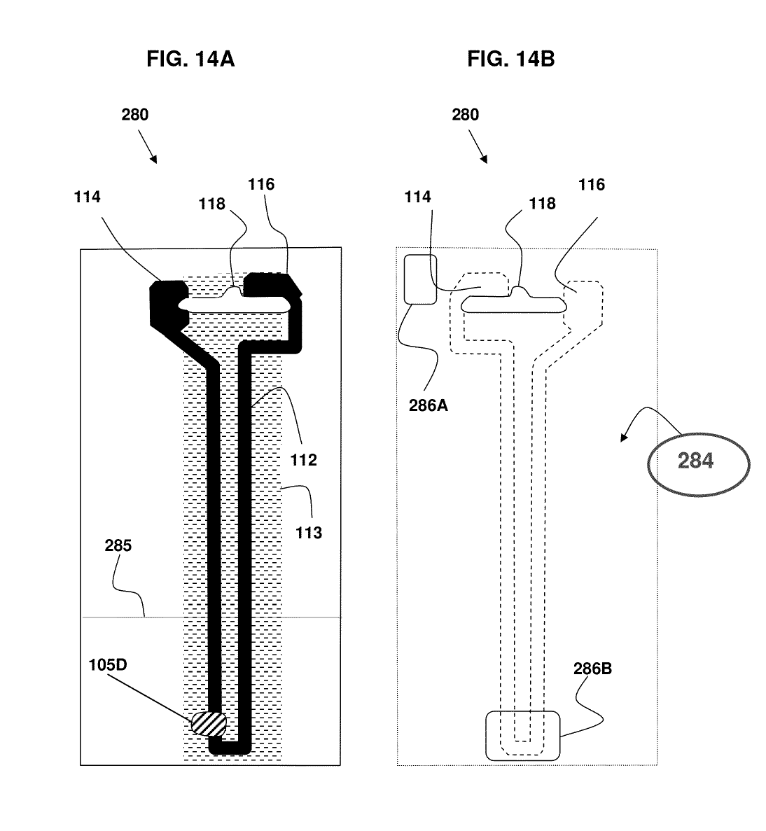

FIGS. 14A-14B show an alternative embodiment where a tether 280 may be used instead of the label 180 of FIGS. 3A-3B. FIG. 14A shows a first side of tether 280 which supports a conductive loop or trace 112 that may be formed of conductive ink. The tether may be formed from a substrate sheet material such as paper, plastic, or the like. Using conductive ink is beneficial because it can be easily printed onto the tether 280. This ink may be printed onto the label using regular printing press methods. The ink should be allowed to dry. It may take up to five minutes or up to ten minutes or longer depending upon conditions for the conductive ink to fully set. The tether may be selectively weakened by perforations, slits, holes, or other weakening features 113 that may make the tether susceptible to tearing under certain circumstances. Such tearing may preferably break the trace 112 and therefore the weakening features 113 may be located proximate to trace 112. The tether 180 may have one or more tether fold lines 285 formed therein, for example to facilitate installation into a package.

FIG. 14B shows the second or reverse side of the label, which may be coated by an optional adhesive (see FIG. 4B) that (if used) may be covered by a release liner 284. However, such adhesive and release liner (if used), may be limited to select portions of the second side (or even of the first side) for example a primary portion 286A that may be helpful for holding the tether in the package, and/or a secondary portion 286B, that may be helpful for attaching to a product in the package. More than two such portions may be provided. The size and shape of tether 280, and the size and shape of any adhesive and release portions, may be chosen according to manufacturing preference. For example the tether may be relatively long if it is to be attached to the lower part of a long product item, or the tether may be relatively short if it is to be attached to the upper part of an item, or to a short item. Secondary portion 286B might be limited to an area in the vicinity of conductive trace 112, provided that the product item would be sized and shaped to contact the adhesive exposed by removal of the secondary portion.

Although the adhesive, the release liner 284, and the areas 286A, 286B are shown on a second side of the tether 280, opposite from the first side, it is also possible that the adhesive, release liner, and areas 286A, 286B might be provided on the same side as the conductive trace 112. Instead of or in addition to supplying an adhesive area 286B on the tether 280, for connecting to a product item, a glue dot or blob 105D may be used to connect either side of the tether to the product item.

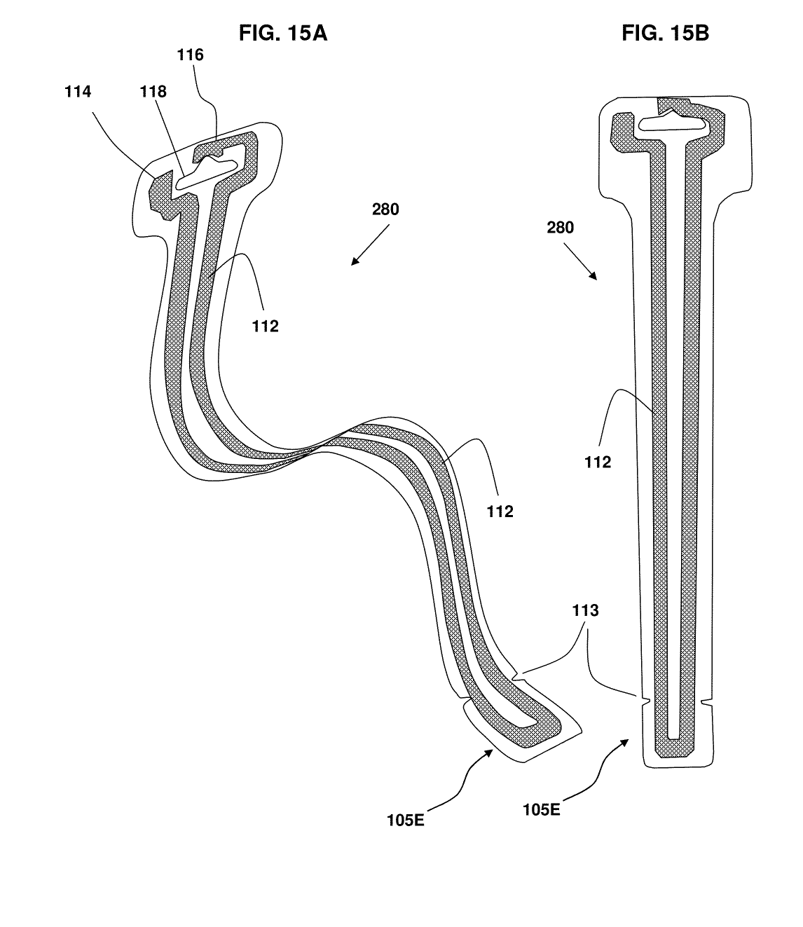

FIGS. 15A-15B show an embodiment of a tether 280 similar to that in FIGS. 14A-14B. FIG. 15A shows a perspective view illustrating the flexible nature of the tether (of course, all or most of the labels and tethers shown herein may be flexible.) FIG. 15B shows a front plan view of the tether. The tether 280 supports a conductive loop or trace 112 that may be formed of conductive ink. The conductive loop or trace may have terminals 114, 116 as previously described. The tether may have a hang hole 118. The tether may be formed from a substrate sheet material such as paper, plastic, or the like. The tether may be selectively weakened by perforations, slits, holes, or other weakening features 113 that may make the tether susceptible to tearing under certain circumstances. Such tearing may preferably break the trace 112 and therefore the weakening features 113 may be located proximate to trace 112. In the instance shown in FIGS. 15A-15B, the weakening feature 113 may be a pair of slits near the end of the tether. An adhesive area 105E may be provided, for example on either or both front and back surfaces at the end of the tether. Such adhesive 105E may be used to attach the tether onto a product item. The shape of any adhesive and release portions may be chosen according to manufacturing preference. For example the adhesive may be placed near the end of the tether as shown to attach to a product item. Adhesive may be provided near the terminals 114, 116 or hang hole 118 to facilitate attachment to a security device as previously described. Adhesive may be provided at other areas as desired for example to attach the tether temporarily or permanently to a carton or carton blank. Instead of having a single conductive trace 112 as show, the tether may include multiple traces, in series or parallel for connecting to multiple product items or multiple points on a single product item.

Instead of or in addition to supplying an adhesive area 105E on tether 280, for connecting to a product item, a glue dot or blob may be used to connect either side of the tether to the product item. Tether 280 may be provided initially without any adhesive, and then a glue dot or blob provided at the time the tether and product item are put into the package.

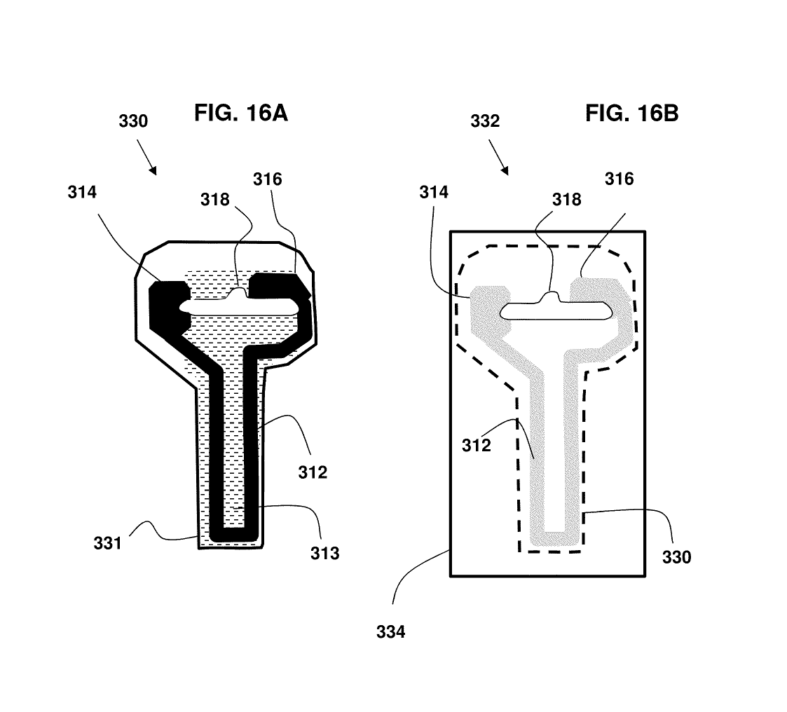

Further embodiments are depicted in FIGS. 16 to 22 which illustrate the use of a flexible transitional support such as an accordion fold holding a portion of conductive trace 312. Such a flexible transitional support may allow the conductive trace to be attached to product items that may not fit well against a wall of the package, or that may move inside the package. It will be understood that the description and accompanying drawings are representative of non-limiting examples of how the present invention can be implemented.

The packages of FIGS. 16 to 22 may be made from one or more blanks (not all shown). The blank or blanks may be formed of paperboard, or other suitable sheet material in alternative embodiments, for example: paper, cardboard, plastics material, coated paperboard and polymer laminated paperboard (such as NATRALOCK®).

FIG. 16A shows a sticker or label 330 which supports a conductive trace 312 with some similarity to that shown in FIG. 1. The label 330 may include a hang hole opening 318, and the contacts 314, 316 at the ends of the conductive trace 312 may be adjacent to the hang hole opening 318. The label may be partly or entirely coated on either or both sides with an adhesive such as a pressure sensitive adhesive (not shown). It will be assumed for this description that the upward-facing surface of the label is coated with an adhesive. Portions 313 of the label may be weakened as with scores, perforations, etc. in order to make the label susceptible to tearing so as to increase its effectiveness as a package intrusion detector.

FIG. 16B shows an assembly 332 including label 330 with a release liner 334 temporarily adhered to the upward facing (i.e., adhesive-coated) surface. The release liner 334 may facilitate handling of the label 330 and may be removed after the label 330 is attached to a package.

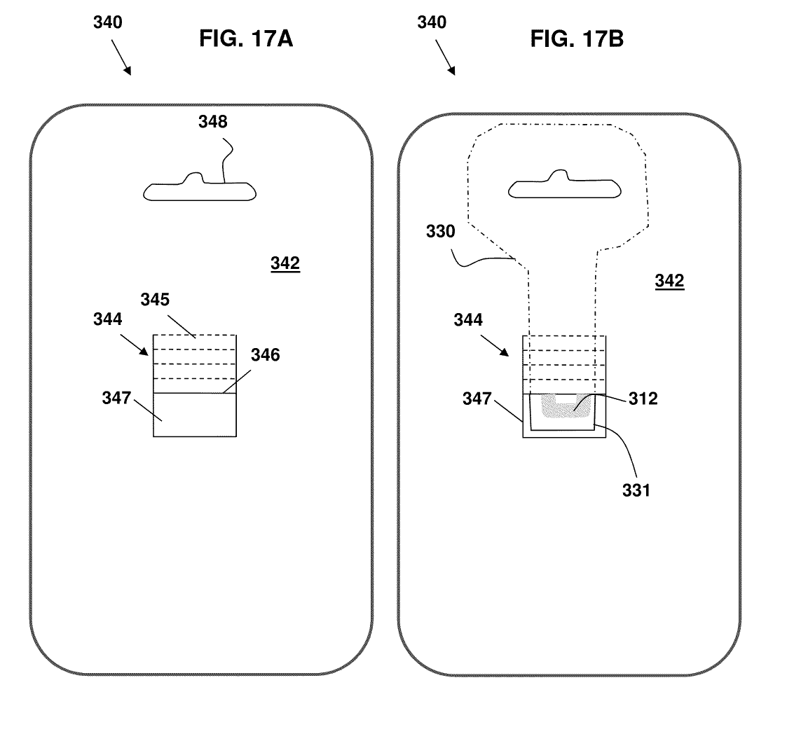

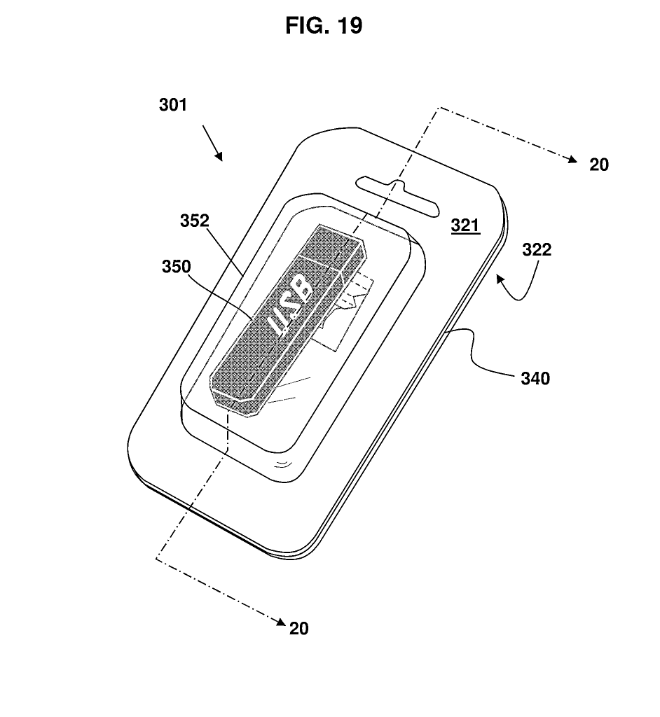

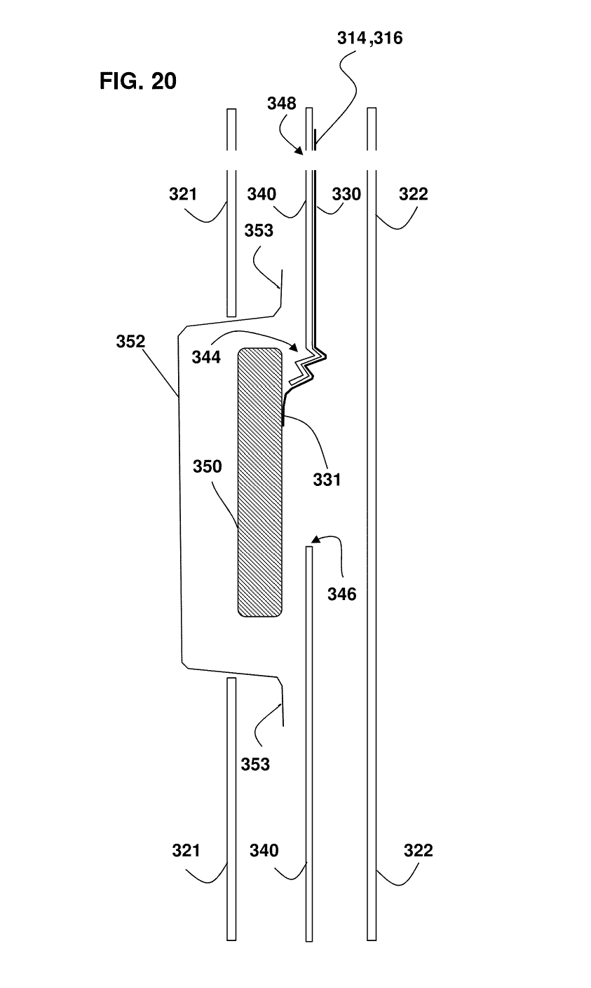

FIGS. 17A and 17B show an insert 340 upon which the label 330 may be placed. The insert 340 may then be placed into a package such as the carton shown in FIG. 1, or the blister card package shown in FIGS. 19 and 20. The insert 340 may be a sheet or card 342, made of material such as paper, paperboard, plastic, etc. In one embodiment the card 342 may be a paperboard with a heat-sealable coating on one or both surfaces. The insert 340 may include a hang hole 348.

In order to provide a flexible transitional support for the conductive trace 312, a flexible tongue 344 may be provided as part of insert 340. The flexible tongue 344 may be a strip of material partially cut away from card 342, while still remaining hingedly attached. The hinged attachment may include one or more folds or crease lines 345. Adjacent to the unattached end 346 of flexible tongue 344 there may be provided an opening 347 in card 342.

FIG. 17B shows the insert 340 with the label 330 adhered to the back of the insert. The lower end 331 of label 330 may be positioned behind opening 347, with a portion of conductive trace 312 exposed through the opening.

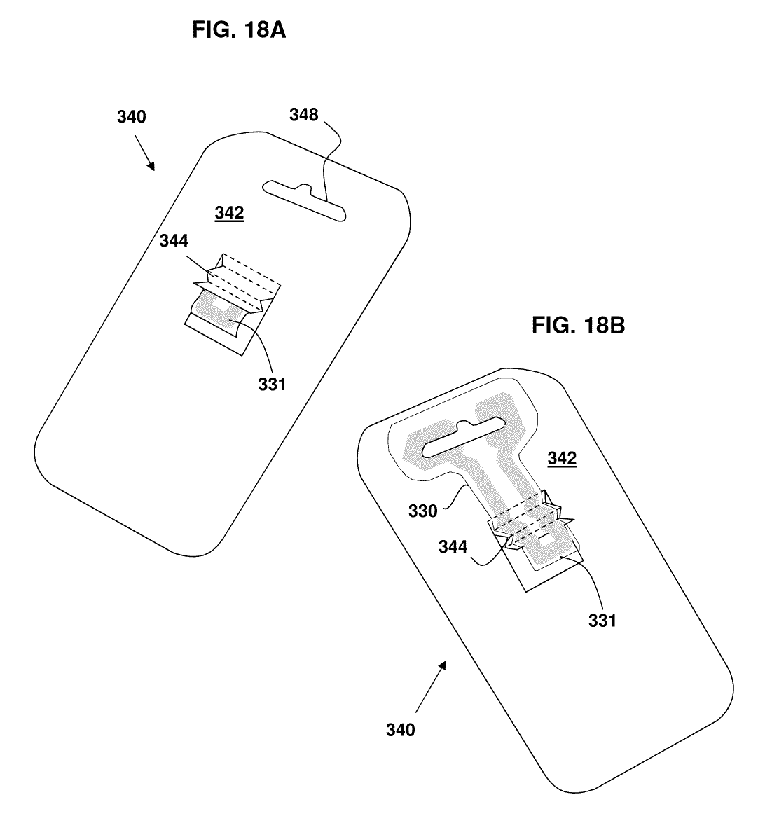

FIGS. 18A and 18B show perspective views of insert 340 from the front and back. The tongue 344 is shown to be accordion-folded along crease lines provided in the tongue. However, the crease lines are optional and may be omitted if the tongue is flexible enough without using crease lines. If used, any number of fold or crease lines may be provided. Label 330 may be adhered to the back of insert 340, with the end 331 extending off tongue 344 and into the open area 347. Since the end 331 is not adhered to the insert 340, it is free to be adhesively attached to a product item.

The size and shape of the label 330, and particularly the end 331 that will be attached to a product item, may be modified according to manufacturing preference, as may the size and shape of the insert 340, and particularly the tongue 344 and the open area 347. A longer tongue 344 (with correspondingly longer end 331) or a more flexible tongue (for example a narrower tongue, or a thinner material, or using more creases or folds) may allow more movement or rougher handling of the package without breaking loose the product item from the end of the label.

FIG. 19 shows a blister card package 301 including a front card 321 and a back card 322 with the insert 340 sandwiched between. A blister 352 may protrude through an opening in front card 321. The blister may hold a product item 350. The end 331 of the label 330 may be attached to the product item. The tongue 344 which supports conductive trace 312 provides flexibility for attaching the conductive trace 312 to irregularly-shaped product items, or items that may move about inside the blister 352. Similarly to the package shown in FIG. 1, a security module 390 may be attached to package 301.

FIG. 20 shows a cross-section view of package 301 taken along the division line “6” of FIG. 19. From left to right in FIG. 20 are depicted the layers of the package from top to bottom, including blister 352, front card 321, product item 350, blister flange 353, insert 340, label 330, and back card 322. The end 331 of label 330 may be adhesively attached to the product item 350 through opening 347. This attachment may be facilitated by the flexible nature of tongue 344.

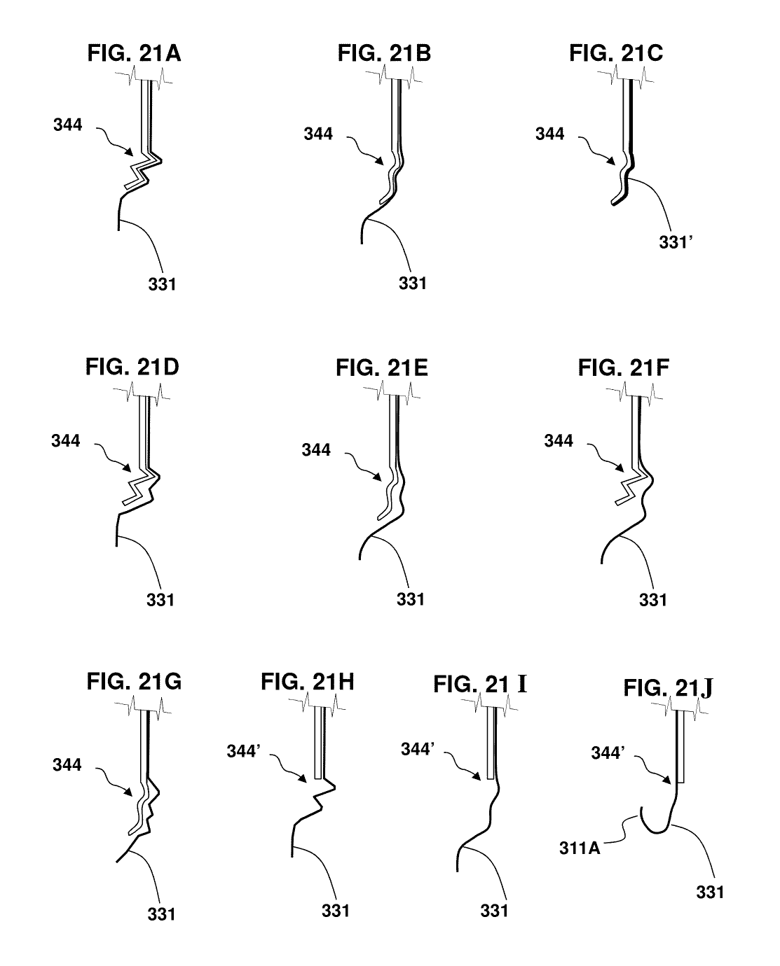

FIGS. 21A-21J show cross-section detail views of variations on the label 330 near its end 331, and on the tongue 344. FIG. 21A repeats the structure shown in FIG. 20, where label 330 near its end 331, and the tongue 344, have pleats or folds and the label near the end is adhered to the tongue. FIG. 21B shows a variation where the label near its end and the tongue rather than being pleated have a smoother profile, for example a curved profile (which might still utilize score or crease lines) and the label near its end 331 is adhered to the tongue. FIG. 21C shows a variation where the end 331′ does not extend past the tongue 344. This could also be achieved with a pleated or folded tongue/end. With such a structure, end 331 (and the rest of the conductive trace) could be part of a label, or could be printed or stamped directly on to the tongue particularly since in this structure the end 331 does not extend past the end of the tongue. However, even if the end 331 extends past the end of the tongue, portions of the conductive trace other than the end 331 might still be printed or stamped onto the tongue or other portions of the insert 340. FIG. 21D shows a variation where the label near end 331 and the tongue 344 have pleats or folds and the label near the end is not adhered to the tongue. FIG. 21E shows a variation where the label near its end, and the tongue, have a curved profile (which might still utilize score or crease lines) and the label near the end 331 is not adhered to the tongue. FIG. 21F shows a variation where the label near end 331 has a curved profile (which might still utilize scores or crease lines) and the tongue 344 is pleated or folded, and the label near its end is not adhered to the tongue. FIG. 21G shows a variation where the tongue 344 has a curved profile (which might still utilize scores or crease lines) and the label near end 331 is pleated or folded, and the label near its end is not adhered to the tongue. FIG. 21H shows a variation absent a tongue (as denoted by 344′) and using a label that is a folded or pleated near end 331. FIG. 21I shows a variation absent a tongue (as denoted by 344′) and using a label that is curved near end 331 (which might still utilize scores or crease lines). FIG. 21J shows a variation where the label may be applied on the side of the tongue facing the product, but the end 311A then curved or bent up so that the adhesive now faces the product.

The conductive trace is shown in the Figures on the back of the insert card 340 (and therefore on the back of the tongue 344). This may be convenient since when the conductive trace is applied as an adhesive label, the adhesive on the end 331 will then face upward or inward into the package, facing the product item within the package. However, the conductive trace may also be on the front of insert card 340 since the tongue 344 and/or the end 331 are somewhat flexible to still allow for adhering the end 331 to a product item contained in the package. If adhesive is not provided on the end 331, then a separately provided adhesive might be used to attach the end to a product item.

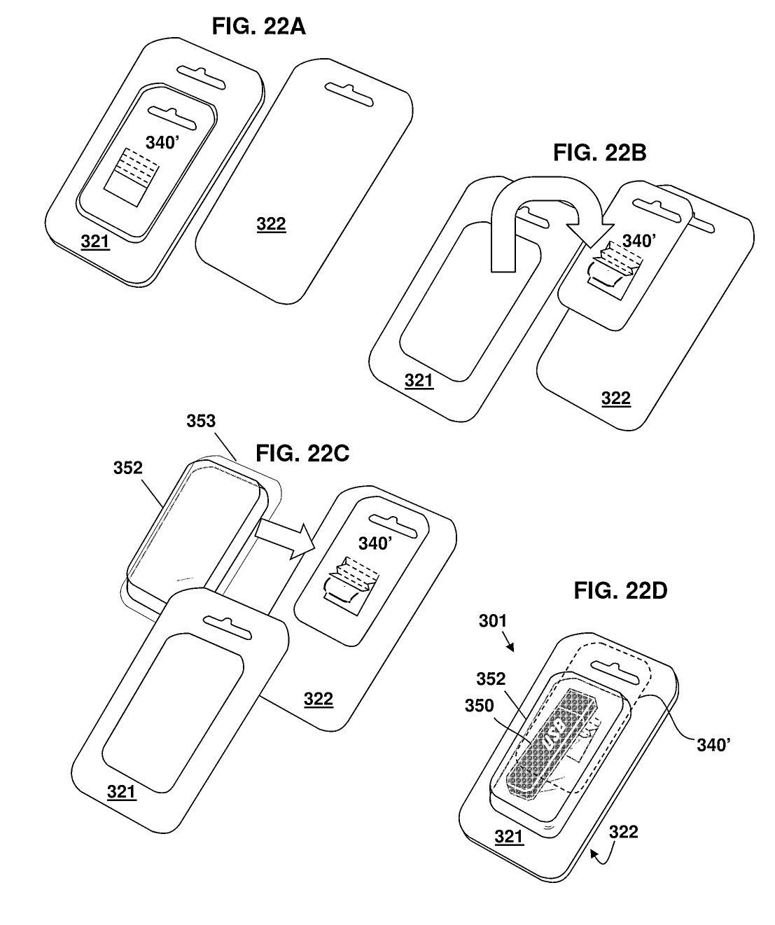

FIGS. 22A-22D show example assembly steps for a package 302. Similar steps could be used with the packages previously described such as package 301. FIG. 22A shows front card 321 and back card 322 provided as separate pieces. However, these cards could also be provided as a single unit, for example hingedly joined along one of the side, the top, or the bottom. An opening may be provided in front card 321, to accommodate blister 352. In this case the material removed from the opening, which might otherwise be discarded, may be used to provide insert card 340′. As shown in FIG. 22B, the insert card 340′ may be removed from front card 321, and placed between the front card 321 and back card 322. The conductive trace may be attached to the insert card 340′. Before putting the front card 321 in place, insert card 340′ may be adhered to or otherwise attached to back card 322, for example using an edge or edges and/or the hang hole(s) to align the insert card 340′ and the back card 322. If the insert card were larger (e.g. as with insert card 340 being approximately the same size as the front and back cards as in FIG. 19) it may be fairly easy to align it properly even after bringing together the front card 321, insert card 340, and back card 322.

As shown in FIG. 22C, a blister 352 may be placed between front card 321 and back card 322, so that the body of blister 352 will fit through the opening in the front card 321, while the blister peripheral flange 353 may be sandwiched between the cards. A product item 350 may be enclosed in the package, as shown in FIG. 22D.

The label 330 supports a conductive loop or trace 312 that may be formed of conductive ink. The label may be formed from a substrate sheet material such as paper, plastic, or the like. Using conductive ink is beneficial because it can be easily printed onto the label 330. This ink may be printed onto the label using any printing method, including but not limited to gravure, offset, flexo, silk screen, inkjet, and so on. The ink should be allowed to dry. It may take up to five minutes or up to ten minutes or longer depending upon conditions for the conductive ink to fully set. However, preferably drying time may be 30 seconds or less, or even as short as about one second. After the conductive ink is printed and set then the label 330 may optionally be further processed for example by application of adhesive and a release liner 334. Alternately adhesive and/or release liner may be omitted. The label may be selectively weakened by perforations, slits, holes, or other weakening features 313 that may make the label susceptible to tearing under certain circumstances. Such tearing may preferably break the trace 312 and therefore the weakening features 313 may be located proximate to trace 312. The label 330 may have one or more label fold lines formed therein.

The size and shape of the separable portions of the release liner 334 may be chosen according to manufacturing preference. The release liner 334 may be in one or more pieces. For example a first portion of the release liner may occupy much of the upper part of label 330 to cover the adhesive that will attach to the insert card 340. A second portion of the release liner may cover the end 331 of the label which may later be removed so the end 331 may be attached to product item 350.

Although the adhesive and release liner are shown on a one side of the label 330, it is also possible that the adhesive and release liner might be provided on the opposite side, on both sides, of the label.

The package may be sealed by joining together back panel extension 109 and top panel extension 106 as previously described herein.

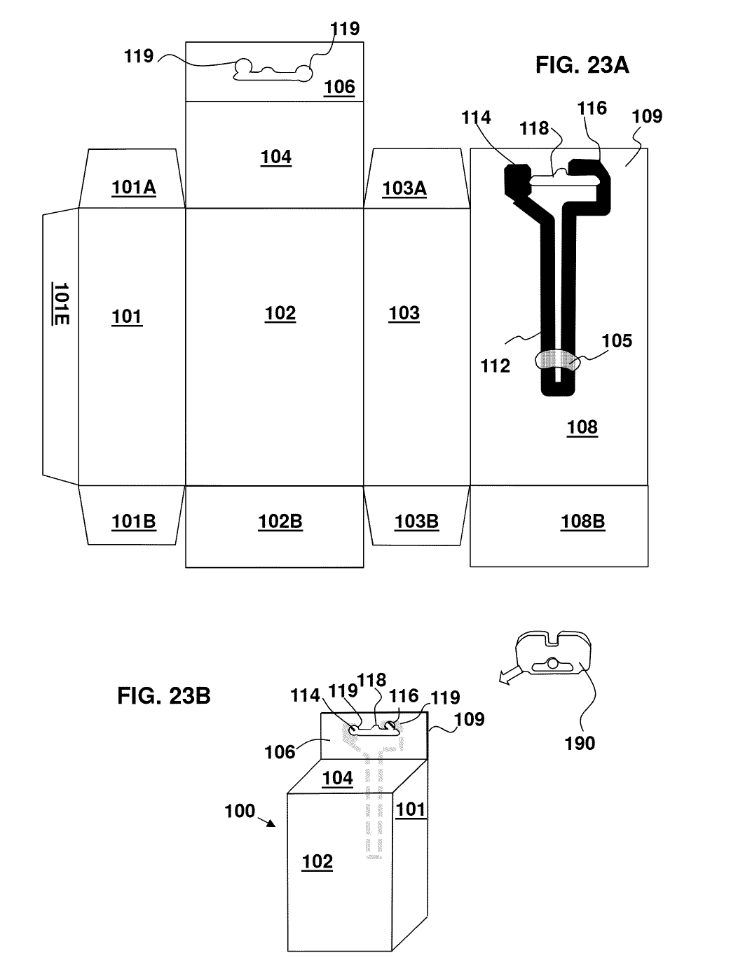

FIGS. 23A through 29D show additional embodiments and details for security cartons or blister cards. FIG. 23A shows a plan view of a blank for making a carton 100 as shown in FIG. 23B, which is generally similar to that shown in FIG. 1. The blank may have panels including right panel 101, front panel 102, left panel 103, back panel 108, and glue panel 101E. These panels may be connected together by fold lines, and when folded may create a rectangular tube with a longitudinal seam formed by attaching glue flap 101E onto back panel 108.

The lower end of the blank may include bottom closure flaps 101B, 102B, 103B, 108B. The upper end of the blank may include top closure flaps 101A and 103A and top panel 104. The package may be sealed by joining together back panel extension 109 and top panel extension 106 as previously described herein.

A conductive trace 112 may be printed or otherwise provided on back panel 108, for example on the inside surface of the back panel. A glue blob 105 may be used to attach a product item 150 (as seen in FIG. 1) to the conductive trace 112. FIG. 23B shows a simplified perspective view of a carton 100 made from the blank of FIG. 23A, with the conductive trace 112 (now hidden inside the carton) shown in dotted lines.

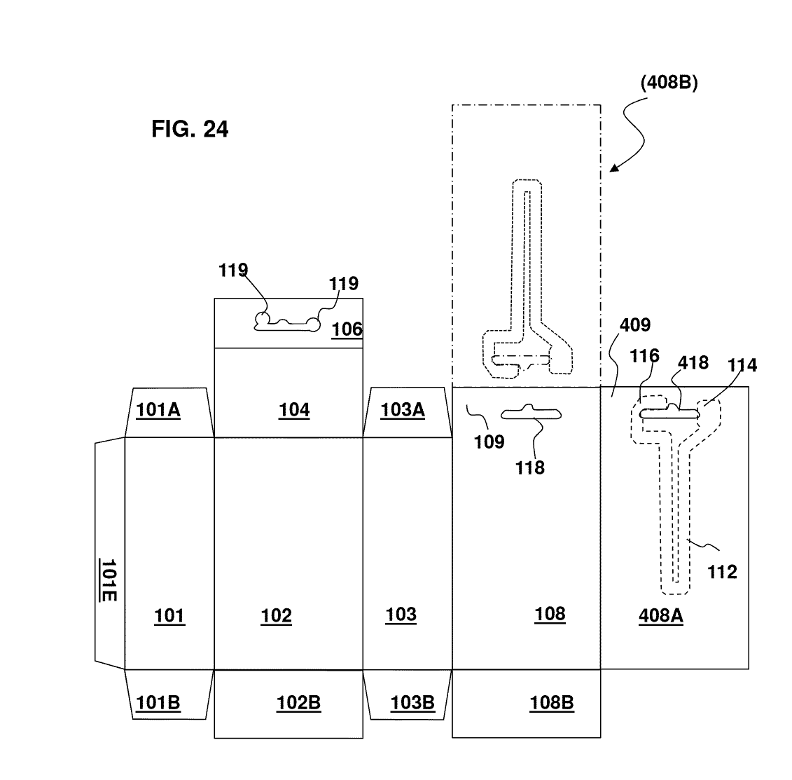

If the conductive trace 112 as shown in FIG. 23A is printed onto the inside of back panel 108, then in most instances both sides of the blank will need to be printed, as the exterior side is almost always printed with advertising and product information. FIG. 24 shows a plan view of an alternative blank for making a security carton with a conductive loop. Instead of providing conductive trace 112 on the inside of back panel 108, an additional panel 408A may be foldably or hinged attached to the back panel 108. The conductive trace 112 (depicted in dashed lines) may be printed or otherwise provided on the ‘outer’ surface of the blank. Thus it may suffice to print only the outer surface of the blank. As shown in FIG. 10, the additional panel 408A may extend sideway (laterally) from back panel 108. However, as shown in phantom view, the additional panel (denoted 408B) may instead extend upward from back panel 108.

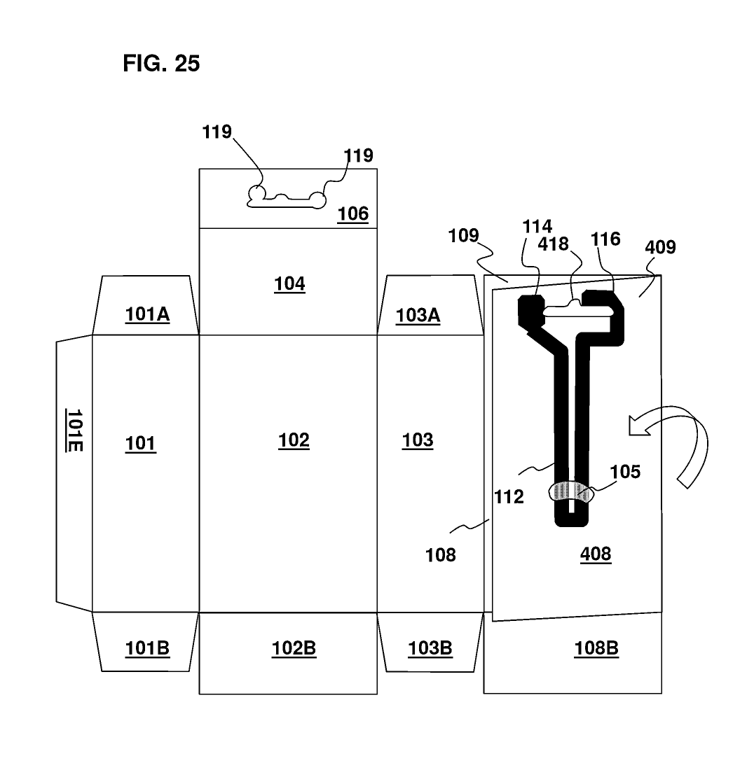

FIG. 25 shows a plan view of the blank of FIG. 10, with the additional panel 408 folded inward onto back panel 108. The conductive trace 112 will now be facing the ‘inside’ surface of the blank and eventually of the carton to be made from the blank. After the carton has been formed, a glue dot 105 or other attachment may be used to secure a product item 150 to the conductive trace 112 (see FIG. 1).

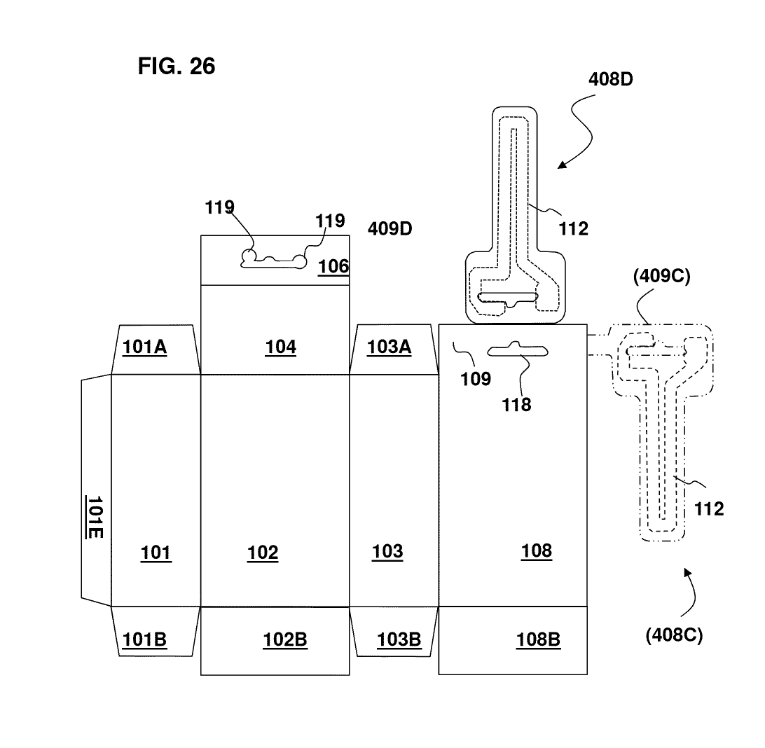

The additional panel 408A (or alternatively 408B) as shown in FIG. 25 may be as large or nearly as large as back panel 108. However, as shown in FIG. 26, an additional panel 408C (or 408D) may be smaller, even significantly smaller than back panel 108. Again as shown in FIG. 26, with additional panel 409C or 409D may be hingedly attached either to the side of the back panel 108, or to the top of back panel 108. Attachment to the upper part 109 of back panel 108 conveniently locates the terminals of the conductive trace near the hang hole. However other attachment points may be possible.

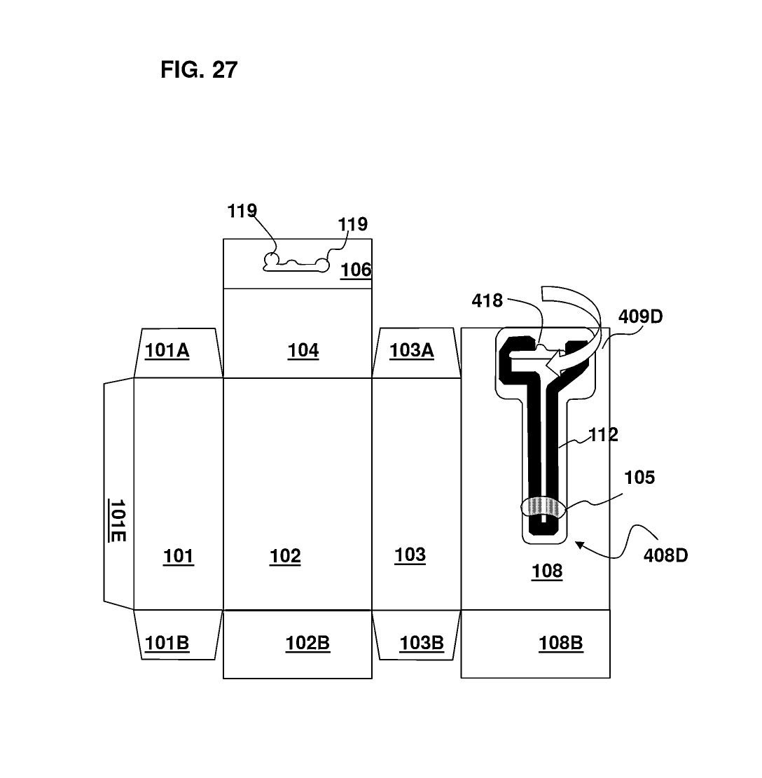

FIG. 27 shows a plan view of the blank of FIG. 11, with additional panel 408D folded inward onto back panel 108. The conductive trace 112 will now be facing the ‘inside’ surface of the blank and eventually of the carton to be made from the blank. After the carton has been formed, a glue dot 105 or other attachment may be used to secure a product item 150 to the conductive trace 112 (see FIG. 1).

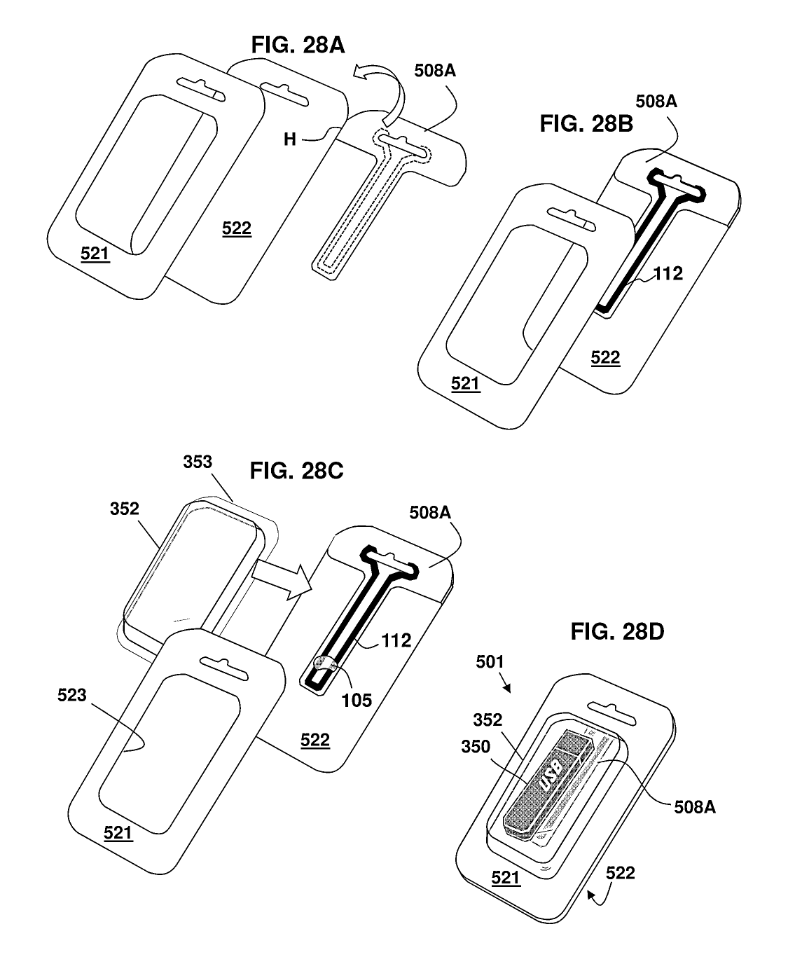

FIGS. 28A-28D show example assembly steps for blister packages 502, 503 that are somewhat like the package 301 seen in FIG. 22D.

FIG. 28A shows front card 521 and back card 522 provided as separate pieces. However, these cards could also be provided as a single unit, for example hingedly joined along one of the sides (for example the left side), the top, or the bottom. An opening 523 may be provided in front card 521, to accommodate blister 352. Hingedly joined to back card 522 (for example along the right side at hinge point H) may be an extension panel 508A on which is provided conductive trace 112 either by printing or other suitable method. The conductive trace may be printed on the back or ‘outer’ surface of the extension panel 508A. As shown in FIG. 28B, the extension panel 508A may then be folded sideways on hinge point H and inward onto the inside surface of back card 522. The hinged attached may help to align the extension card with the back card.

As shown in FIG. 28C, a blister 352 may be placed between front card 521 and back card 522, so that the body of blister 352 will fit through the opening 523 in the front card 521, while the blister peripheral flange 353 may be sandwiched between the cards. A product item 350 may be enclosed in the package, as shown in FIG. 28D. A glue dot 105 or other method may be used to secure product item 350 to conductive trace 112.

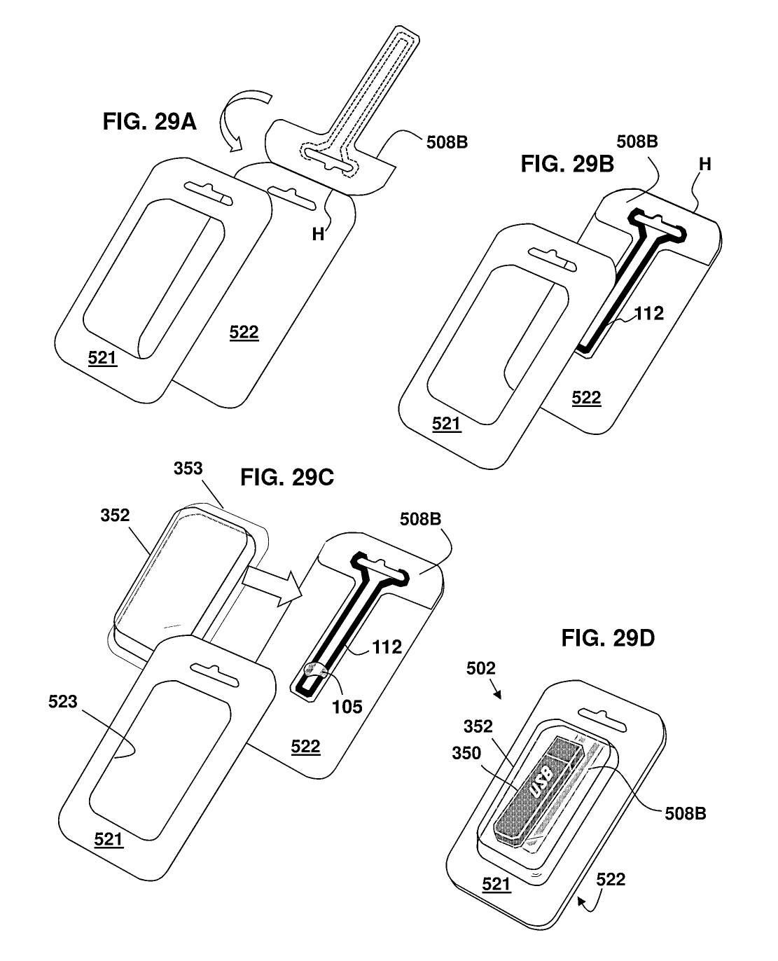

FIG. 29A shows front card 521 and back card 522 provided as separate pieces. However, these cards could also be provided as a single unit, for example hingedly joined along one of the sides or the bottom. An opening 523 may be provided in front card 521, to accommodate blister 352. Hingedly joined to back card 522 (for example along the top edge at hinge point H) may be an extension panel 508B on which is provided conductive trace 112 either by printing or other suitable method. The conductive trace may be printed on the back or ‘outer’ surface of the extension panel 508B. As shown in FIG. 29B, the extension panel 508A may then be folded forward on hinge point H and inward onto the inside surface of back card 522. The hinged attached may help to align the extension card with the back card.

As shown in FIG. 29C, a blister 352 may be placed between front card 521 and back card 522, so that the body of blister 352 will fit through the opening 523 in the front card 521, while the blister peripheral flange 353 may be sandwiched between the cards. A product item 350 may be enclosed in the package, as shown in FIG. 29D. A glue dot 105 or other method may be used to secure product item 350 to conductive trace 112.

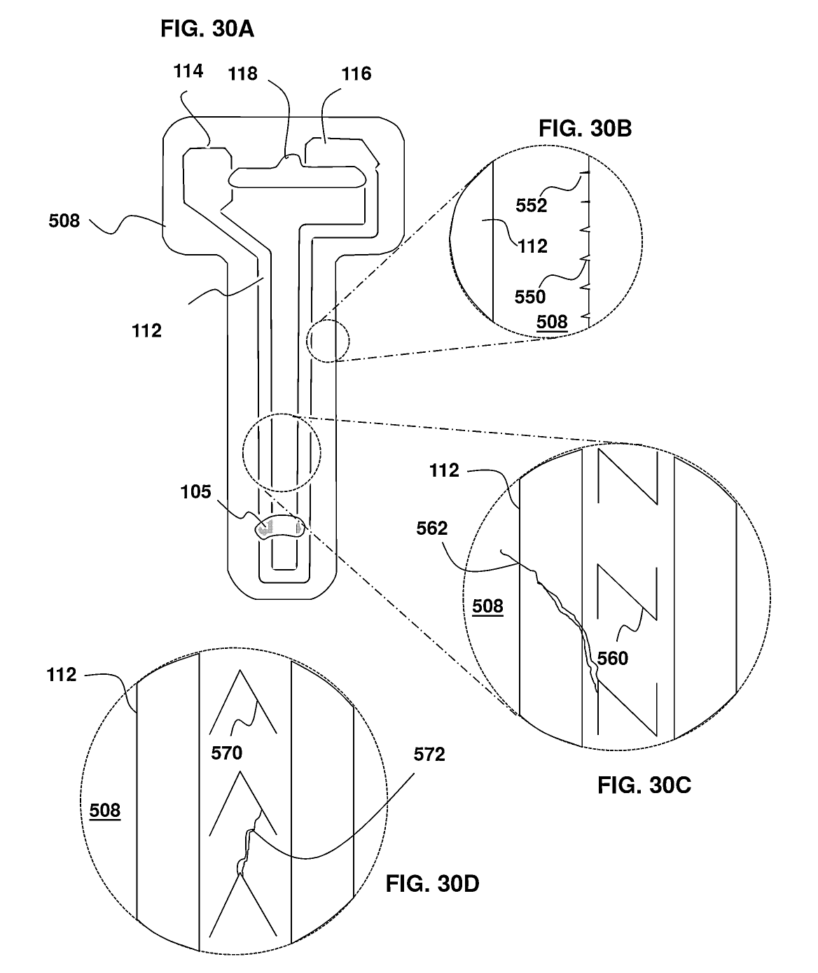

FIG. 30A shows a conductive trace 112 supported on an extension panel 508. A product item (e.g. product item 150 in FIG. 1) may be attached to the conductive trace by a glue dot 105 or other attachment method.

The details shown in FIGS. 30B and 30C apply to a conductive trace supported on any panel or substrate. It is desired that any attempt to remove a product item will cause the conductive trace 112 to be broken. Therefore the glue dot 105 should be cohesive enough that a force attempting to remove a product item from the conductive trace will not separate or split the glue dot itself. Furthermore it is desired that the glue dot 105 should adhere to the product item so strongly that the glue dot instead of separating from the product item 150, will instead tear loose from the substrate forming extension panel 508.

It is desired that pulling on the glue dot should open the conductive trace 112, either by tearing the substrate and thereby severing the conductive trace, or by delamination a portion of the substrate surface and creating a gap or break in the trace. To encourage breaking of the trace 112, weakening features such as notches 550 or nicks or cuts 552 may be made in the perimeter of the extension panel 508. However, placing weakening feature in the perimeter of extension panel 508 could cause it to tear during normal handling if the product moves around inside the carton. Thus a different tear-directing feature might be more advantageous.

Another method to encourage breaking of the trace 112 is shown in FIG. 30C, where weakening features 560 may be made in the along the conductive trace 112. For example “N” or “Z” shaped cuts may encourage a tear or delamination 562 to move into the conductive trace 112, regardless which direction a peeling force is exerted. On the other hand “V” or inverted V shaped cuts 570 as shown in FIG. 30D may encourage a tear or delamination 572 to propagation parallel to the conductive trace, or to tear away portions of the surface between the two traces rather than tearing across the trace.

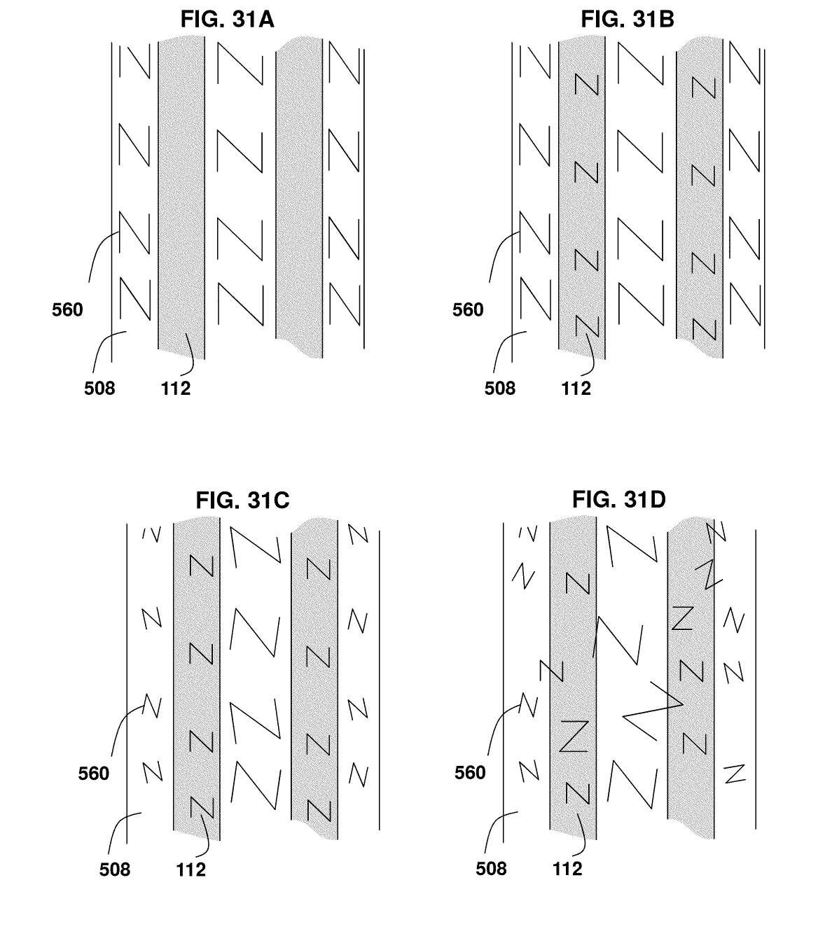

FIGS. 31A-31D show detail views of various example patterns of weakening features 560 in conductive trace 112. FIG. 31A depicts the use of somewhat uniformly sized “N” cuts. The cuts may be in one or more generally linear series, although they need not be exactly in line. As shown, a series of cuts may extend longitudinally along or generally parallel with the conductive trace 112, without necessarily being made into the conductive trace 112 itself. Alternately or additionally, one or more series of cuts may extend across the tether (not shown) either perpendicular to the conductive trace or tether, or at an angle or angles to the conductive trace or tether. FIG. 31B shows various sizes of “N” cuts, again in several generally linear series extending longitudinally with conductive trace 112, either on conductive trace 112 itself, or alongside conductive trace 112. These series of cuts may also extend across the tether either perpendicular or at an angle to the length of the tether. FIG. 31C shows various sizes of “N” cuts at various angles. FIG. 31D shows various sizes of cuts, at various angles, and somewhat randomly located on the tether. These are only a few of the many weakening patterns that may be used. The weakening features 560 may be cut entirely through the tether or label, or may be cut only partially through.

None of the cuts in FIGS. 31A-31D extend to the edge of the tether. However, in some embodiments, one or more cuts may extend to the edge of the tether.

With regard to the presence of conductive trace 312 on the label (and later within the package) It is to be understood that a variety of tools may be used to apply the graphics to the package and/or seal the package, and that each set of tools may influence the appropriate pressure and temperature ranges that may be applied without disrupting the functionality of the conductive ink. A broad range of temperatures and pressures may be used to seal the package, for example, but not limited to, a pressure of 20 to 80 psi and a temperature of 300-400° F. In one example, the package may be sealed using a pressure of about 50 psi and a temperature of about 350° F. Other ranges for pressure and temperatures may also work to seal and print the graphics without damaging the ink's conductive properties depending upon the conditions, equipment and materials used. Damage or change in the conductive properties of the conductive ink material could cause the security feature to fail. The pressure and temperature limits may vary based on the materials used. Development of conductive inks may alter these temperature and pressure considerations. It is to also be understood that the exact order of these sequences may be adjusted depending upon manufacturing preferences.

The conductive ink used for printing the security loop may be replaced with other suitable means for allowing an interruption of that loop to be conveyed to an alert means. Other electrically conductive materials readily could be used in replacement of or in combination with the conductive ink, for example: foil ribbon, wire and conductive plastics or polymer material. In the present example, a conductive material is used so that a break or interruption in the security loop 312 causes an increased resistance within an electronic circuit to which the security loop 312 is coupled which results in an alarm sounding. The security loop 312 or label 330 may be formed from material that can readily be torn through so that the presence of a security loop incorporated within the package does not hinder a consumer gaining access to their article once the product has been purchased. It is to be understood that the module connected to the security loop may also be designed to interact with other anti-theft devices in a store. For example it could also be designed to sound if the entire package is removed from the building (e.g. when the package crosses security detection devices placed at the doors).

Similarly to the structure shown in FIG. 1, and depending on the position of the conductive trace 312, contact holes 319 may be provided in the front card 321 or back card 322, or both. Such contact holes 319 may be superimposed upon contacts 314, 316 to provide a good electrical contact area for the security module 390, including optionally allowing for a clamping force or a conductive adhesive to help maintain good electrical contact.

Ideally any adhesive used on label 330 will be attached to or adhere strongly to the product 350, yet be capable of being removed from the product without excessive effort after purchase, either by peeling, scraping, dissolving, or otherwise removing the adhesive from product 350. The product may advantageously be close to the label 330, for example in close facing contact, so that a knife cannot be inserted between the product and the package to cut through the adhesive without breaking the conductive pathway 312.

Weakening features 113, 313 have been described above that may be used on the tethers to increase the likelihood that the conductive trace 112 will be broken if an attempt is made to remove disconnect the product from the tether, or the tether from the package. Such weakening features may be further developed as will now be described.

It may be desired that the weakening features are quite likely to break the conductive trace 112 in the case of attempted theft, but are not likely to break the conductive trace during assembly of the package, loading its contents, shipping, and routine handling by a customer. For example if the carton of FIG. 8 is dropped or shaken, the contents 150 may move within the package and could tear the conductive trace. Also if the blister card package 301 of FIG. 19 is dropped during shipment, product item 350 may pull on label 330 and could tear the conductive trace. A weakening feature 113 in the form of a notch in the edge of tether 280 in FIGS. 29A-29B might possibly lead to inadvertent tearing of the tether during routine handling. Thus it would be desirable to create weakening features that withstand general handling but are very likely to disrupt the conductive trace in the event of attempted theft. One method to achieve such weakening features is to use a cut pattern to promote controlled tearing of a substrate on which the conductive trace is made.

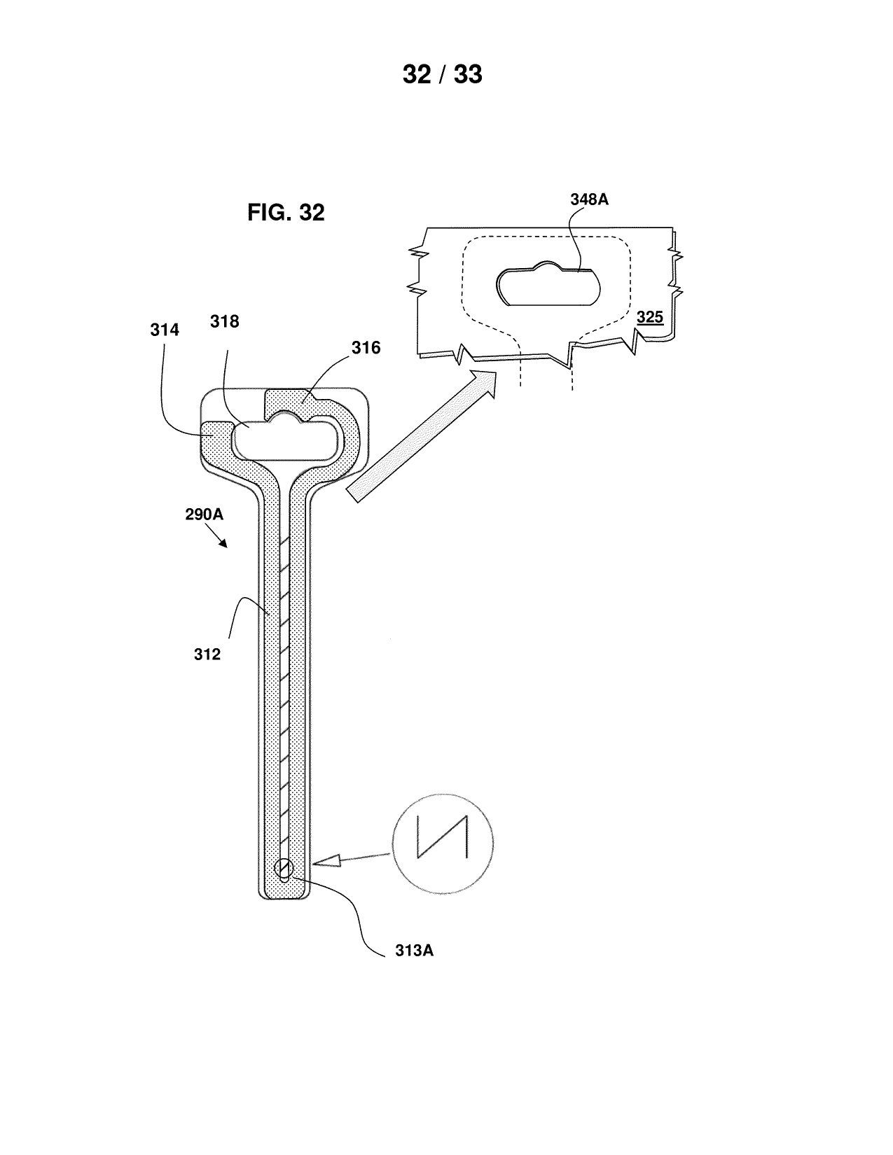

FIG. 32 shows a tether 290A which includes a conductive trace 312. The tether 290A may be made of a substrate such as plastic film, paper, paperboard, etc. The conductive trace 312 includes a pair of generally parallel paths extending lengthwise along the tether 290A and spaced apart a small distance. A series of “N” shaped cuts 313A are made down the center of the tether, close to the conductive trace 312 and between the pair of generally parallel paths. The cuts may also be made at least partly into the conductive trace 312 (provided they do not break the continuity or unduly increase the resistance of the conductive trace. The cuts may also be on areas of the tether near its edges, but the cuts do not necessarily extend to the edges of the tether. Thus, routine movement of the tether is unlikely to initiate tearing via cuts 313A. The tether may be adhesively attached to the product, as described previously. An attempt to remove the tether from the product will pull on cuts 313A and result in cuts 313A initiating a tear or tears that are likely to break the conductive trace 312.

Different cut shapes may give different results. Thus the shape and location of the cuts may be tailored to give optimal results for a given package and product item.

A “{” or “<” cut will allow for tearing when pulled on from the left.

A “}” or “>” cut will allow for tearing when pulled from the right.

A “{ }” or “< >” cut will cause a tear from pulling from either the left or the right, but this tear will terminate upon reaching its opposite end of the cut.

A “Z” cut has been found to be beneficial and will allow for initiated tearing from both the left and the right.

The particular shapes of cut may be rotated at any desired angle. For instance, s non-limiting examples, “<” could be rotated to “̂”. A “Z” shaped cut could be rotated to become an “N” shaped cut such as cuts 313A in FIG. 32.

As already described, but shown again in FIG. 32, tether 290A may be placed on or within a panel 325 of a carton, card, etc. For example a hang hole opening 318 may be provided in tether 290A, which may be superimposed over hang hole opening 348A in panel 325. Contacts 314, 316 at the ends of the conductive trace 312 may be adjacent to the hang hole opening 348A.

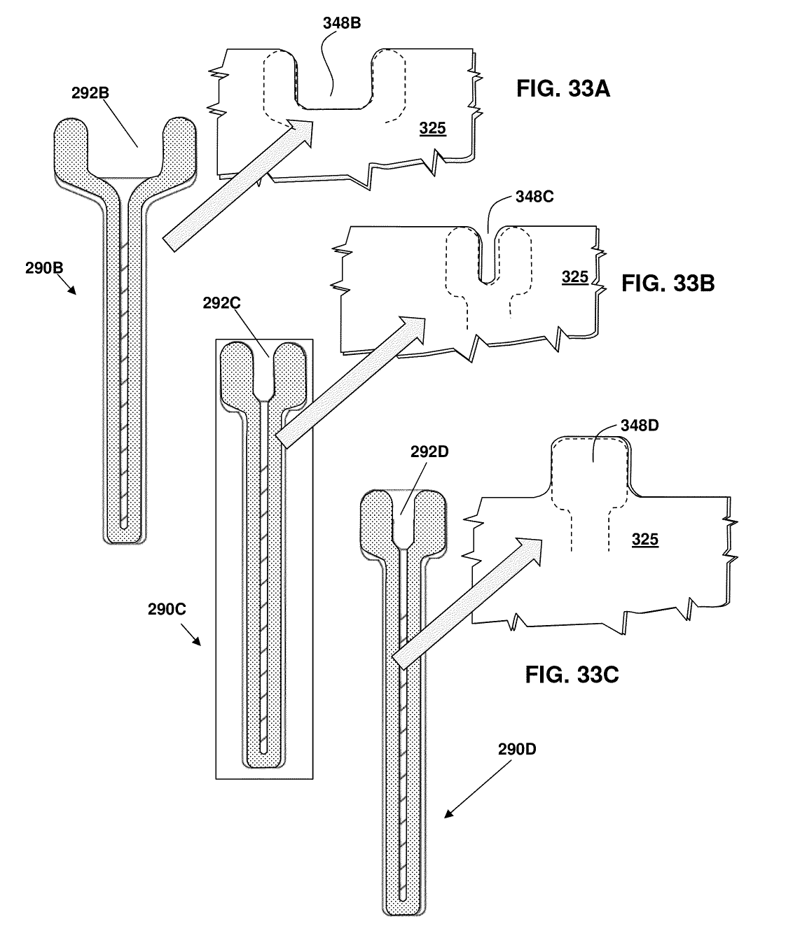

FIGS. 33A-33C show additional embodiment of a tether similar to that in FIG. 31, but shaped for use with different package (e.g. carton or card) structures. FIG. 33A illustrates a tether 290B adapted for use with a slot opening 348B, for example on the edge of a carton or card panel 325. FIG. 33B illustrates a tether 290C adapted for use with a narrow slot or slit opening 348C, for example on the edge of a carton or card panel 325. FIG. 33C illustrates a tether 290D adapted for use with a tab 348D, for example extending from the edge of a carton or card panel 325. In each of these cases the contacts 314, 316 (see FIG. 31) are accessible for attaching to a security module 190 (See FIGS. 1, 11, 12). The security module may be designed according to manufacturing preference to attach to a desired target location, whether it is a hang hole, wide slot, narrow slot or slit, extending tab, or other target point on a carton, card, or other type of package.

An adhesive area may be provided, for example on either or both front and back surfaces at the end of the tethers in FIGS. 32-33. Such adhesive may be used to attach the tether onto a product item. The shape of any adhesive and release portions may be chosen according to manufacturing preference. For example the adhesive may be placed near the end of the tether to attach to a product item. Adhesive may be provided near the terminals 314, 316 or hang hole 318 to facilitate attachment to a security device as previously described. Adhesive may be provided at other areas as desired for example to attach the tether temporarily or permanently to a carton or carton blank. Instead of having a single conductive trace 312 as show, the tether may include multiple traces, in series or parallel for connecting to multiple product items or multiple points on a single product item.

Instead of or in addition to supplying an adhesive area on the tether, for connecting to a product item, a glue dot or blob may be used to connect either side of the tether to the product item. The tether may be provided initially without any adhesive, and then a glue dot or blob provided at the time the tether and product item are put into the package.

It will be recognized that various features of different embodiments as described herein may be utilized in combination with each other.

Although the examples shown in the Figures incorporate a single security loop, it should be understood that more than one security loop may be used. For example, the single security loop shown in the Figures may be replaced by a first security loop around the perimeter of a blister, and a second security loop underlying the blister area and optionally containing a gap to be broken if the contents are removed. The first and second security loops may each have their own contacts to connect to an external security module. The security module in turn may have one pair of contacts for the first security loop and another pair of contacts for the second security loop. Portions of the circuitry within the security module, such as the resistance-measuring circuitry, may be duplicated to serve the second security loop. Some portions of the circuitry within the security module may be shared between both loops, for example the battery, switch, and audible alarm.

The security loop may have a different shape from that shown in FIGS. 16-20. Other designs may be formed according to manufacturing preference to securely monitor other numbers of products in columns, rows, arrays, etc.

Optionally, the security module 190 may cover or obscure an easy-open feature such as a nick, tear, or cut in the package, by which the package can be opened after removal of the security module. For example, the package may be formed with a notch or cut in one or more of the panels, and the security module when installed may cover or otherwise obscure the notch or cut, and prevent access thereto. Once the security module has been removed, the package may readily be opened using the easy-open feature. The notch or cut may be provided in the package during its fabrication, and then covered by the security module. Alternately, the security module may create the tear in the package when the security module is installed.

It can be appreciated that various changes may be made within the scope of the present invention, for example, the size and shape of the panels and aperture may be adjusted to accommodate blisters and articles of differing size or shape. In other embodiments of the invention it is envisaged that the package will include more than two panels and/or that the articles themselves may not be on direct display through a blister or similar transparent material, but rather fully contained and enclosed within the package. The security loop may be printed onto a number of panels of the carton blank, which when folded and glued to form a complete carton are aligned so that a continuous security loop is formed and opening of the carton will cause an interruption or complete breaking of the security loop.

It is envisioned that in other embodiments of the invention, a single electronic circuit capable of detecting interruptions in more than one security loop is accommodated within a single security module 190. In such embodiments, more than one continuous security loop is incorporated within the package for protecting the articles within that package. This is useful where more than one article is contained within a single package.

It will be recognized that as used herein, directional references such as “top,” “bottom,” “front,” “back,” “end,” “side,” “inner,” “outer,” “upper” and “lower” do not limit the respective panels to such orientation, but merely serve to distinguish these panels from one another. Any reference to hinged connection should not be construed as necessarily referring to a single fold line only; indeed it is envisaged that hinged connection can be formed from one or more of the following, a short slit, a frangible line or a fold line without departing from the scope of the invention.

It will be recognized that where lists of examples have been given in the above description, these exemplary lists are non-exhaustive and represent only some suitable options for variations of the invention and should not, in anyway, be construed as constituting an exhaustive, finite limitation of the invention's application.

1. An insert for inserting into or onto a carton and connecting to a security device, the insert comprising:
a substrate sheet,
a conductive trace on the substrate sheet, and
a plurality of cuts through the substrate sheet, wherein the cuts do not extend to the edge of the substrate sheet.

2. The insert of claim 1, wherein the conductive trace is conductive ink.

3. The insert of claim 1, wherein the cuts are in the form of N or Z shapes.

4. The insert of claim 1, wherein the conductive trace comprises a pair of generally parallel portions and the plurality of cuts is located between the generally parallel portions.

5. The insert of claim 1, wherein the plurality of cuts comprise a generally linear series of cuts extending generally parallel with the conductive trace.

6. The insert of claim 1, wherein the plurality of cuts comprise a generally linear series of cuts extending generally perpendicular or at an angle to the conductive trace.

7. (canceled)

8. The insert of claim 1, further comprising an adhesive on at least a portion of the substrate sheet.

9. The insert of claim 8, further comprising a release liner covering at least a portion of the adhesive.

10. The insert of claim 1, wherein the conductive trace has two terminals, each terminal providing an attachment point for a security device.

11. A package containing the insert of claim 1.

12. A package containing the insert of claim 8 and a product item adhered to at least a portion of said adhesive in a product contact area, the product contact area in proximity to at least a portion of the conductive trace.

13. A package containing the insert of claim 1 wherein the insert is adhered to the inside of the package.

14. A package containing the insert of claim 8 and a product item adhered to at least a portion of said adhesive in a product contact area, the product contact area in proximity to at least one of the cuts, the package further comprising a security device connected to the conductive trace.

15. A package according to claim 10, comprising an aperture in the package, wherein the terminals are located in close proximity to the aperture.

16. A package according to claim 15, wherein the aperture is a hang hole.

17. A package according to claim 10, comprising a slot or slit in the package, wherein the terminals are located in close proximity to the slot or slit.

18. A package according to claim 10, comprising a tab extending from an edge of the package, wherein the terminals are located on the tab.

19. A kit of parts for forming a package, comprising:
the insert of claim 1, and
a paperboard carton sized to receive the insert.

20. A kit of parts for forming a package, comprising:
the insert of claim 1, and
a paperboard blank for forming a carton sized to receive the insert.
